(19) United States
(12) Patent Application Publication
(10) Pub. No.: US 2008/0199807 A1
(43) Pub. Date: Aug. 21, 2008

(54) OPTICAL INFORMATION RECORDING MEDIUM, METHOD OF RECORDING INFORMATION AND METHOD OF USING COMPOUND

(75) Inventors: Keita Takahashi, Kanagawa (JP); Kazutoshi Katayama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/029,561

(22) Filed: Feb. 12, 2008

(30) Foreign Application Priority Data
Feb. 16, 2007 (JP) 036315/2007

(51) Int. Cl. G11B 7/24

(52) U.S. Cl. 430/270.11; 430/321

(57) ABSTRACT

The optical information recording medium comprises a recording layer comprising a dye on a support. The recording layer comprises a compound comprising a substituent having a property of producing a gas by thermal decomposition. The method of recording information on the recording layer comprised in the above optical information recording medium by irradiation of a laser beam onto the optical information recording medium. The method of using a compound comprising a substituent having a property of producing a gas by thermal decomposition as an additive in a solution comprising a dye.

### CROSS-REFERENCE TO RELATED APPLICATIONS

This application claims the benefit of priority under 35 USC 119 to Japanese Patent Application No. 2007-036315 filed on Feb. 16, 2007, which is expressly incorporated herein by reference in its entirety.

### BACKGROUND OF THE INVENTION

### FIELD OF THE INVENTION

The present invention relates to an optical information recording medium and a method of recording information permitting the recording and reproducing of information with a laser beam, More particularly, the present invention relates to a heat mode-type optical information recording medium and a method of recording information suited to the recording of information by irradiation of a short-wavelength laser beam with a wavelength of equal to or lower than 440 nm. The present invention further relates to a method of using a compound having a prescribed substituent as an additive in a dye-containing solution.

### DISCUSSION OF THE BACKGROUND

The recordable CD (CD-R) and recordable DVD (DVD-R) have been known as optical information recording media permitting the “write-once” recording of information with a laser beam. In contrast to the recording of information on a CD-R, which is conducted with a laser beam in the infrared range (normally, at a wavelength of about 780 nm), the recording of information on a DVD-R is conducted with a visible light laser beam (with a wavelength of about 630 to 680 nm). Since a recording laser beam of shorter wavelength is employed for a DVD-R than for a CD-R, the DVD-R has an advantage of being able to record at higher density than on a CD-R. Thus, the status of the DVD-R as a high-capacity recording medium has to some degree been ensured in recent years.

Networks, such as the Internet, and high-definition television have recently achieved widespread popularity. With high-definition television (HDTV) broadcasts near at hand, demand is growing for high-capacity recording media for recording image information both economically and conveniently. However, the development of high-capacity disks capable of recording with laser beams of even shorter wavelength is progressing. CD-R and DVD-R do not afford recording capacities that are adequate to handle future needs. Accordingly, to increase the recording density by using a laser beam of even shorter wavelength than that employed in a DVD-R, the development of high-capacity disks capable of recording with laser beams of even shorter wavelength is progressing. For example, Japanese Unexamined Patent Publication (KOKAI) Nos. 2001-277720 and 2002-301870 or English language family member US 2003/138728 A1, which are expressly incorporated herein by reference in their entirety, disclose optical information recording media for recording information with laser beams with wavelengths that are even shorter than the conventional recording wavelengths.

Japanese Unexamined Patent Publication (KOKAI) No. 2003-1942 or English language family member U.S. Pat. No. 5,492,744, which are expressly incorporated herein by reference in their entirety, describe lowering the temperature at which dye decomposition begins by adding a ferrocene to a recording layer containing a phthalocyanine dye to improve pit edge control.

In optical information recording, it is desirable to employ a recording layer dye having absorption near the wavelength of the recording laser beam. As the result of investigation, the present inventors found that although the dyes employed in the recording layers of the optical information recording media described in Japanese Unexamined Patent Publication (KOKAI) Nos. 2001-277720 and 2002-301870 are suited to recording in the short-wavelength region, their recording characteristics are not necessarily of an adequate level. The present inventors further discovered that even when the ferrocenes described in Japanese Unexamined Patent Publication (KOKAI) No. 2003-1942 are added to the recording layers of the optical information recording media described in Japanese Unexamined Patent Publication (KOKAI) Nos. 2001-277720 and 2002-301870, satisfactory improvement of recording characteristics is not achieved.

### SUMMARY OF THE INVENTION

An aspect of the present invention provides for an optical information recording medium exhibiting excellent recording characteristics in information recording by irradiation of a short-wavelength laser beam, and a method of recording information permitting good recording by irradiation of a short-wavelength laser beam.

In optical information recording, irradiation of a laser beam onto an optical information recording medium causes the irradiated portion of the recording layer to absorb the laser beam, locally raising the temperature. This produces a physical or chemical change (such as generating pits), thereby altering the optical characteristics and recording information. Reading (reproduction) of information is conducted by irradiation of a laser beam of the same wavelength as the laser beam employed in recording, for example, onto the optical information recording medium, and detecting the difference in the refractive index between portions where the optical characteristics of the recording layer have been changed (recorded portions) and portions where they have not (unrecorded portions). Thus, the greater the difference in refractive index between recorded portions and unrecorded portions, the greater the reading precision. As a result of investigation, the present inventors have found that in the optical information recording media described in Japanese Unexamined Patent Publication (KOKAI) Nos. 2001-277720 and 2002-301870, satisfactory recording characteristics are not achieved because an adequate difference in refractive index before and after recording is not achieved.

Accordingly, the present inventors conducted extensive research on the basis of the above, resulting in the discovery that when a compound comprising a substituent generating a gas by thermal decomposition was incorporated into the recording layer, the thermal decomposition of the compounds during recording formed voids in pits, achieving a large difference in refractive index. The present invention was devised on this basis.

An aspect of the present invention relates to an optical information recording medium comprising a recording layer comprising a dye on a support, wherein said recording layer comprises a compound comprising a substituent having a property of producing a gas by thermal decomposition.

The above compound may have no absorption for a laser beam irradiated onto the optical information recording medium to record information.

The above dye may have a property of generating heat through absorption of a laser beam irradiated onto the optical information recording medium to record information, and the compound has a property of decomposing by the heat generated by the dye.

The above laser beam may have a wavelength ranging from 390 to 440 nm.

The above substituent may be a monovalent substituent denoted by general formula (I) or (VII).

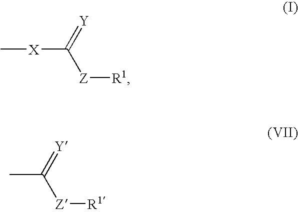

[In general formulas (I) and (VII), R¹ and R^{1′} each independently denote an alkyl group, X denotes NR², a sulfur atom, or CR³R⁴, R², R³, and R⁴ each independently denote a hydrogen atom or a monovalent substituent, Y, Y′, Z, and Z′ each independently denote an oxygen atom or a sulfur atom.]

X in general formula (I) may denote NR².

The above compound may be a compound denoted by general formula (V) or (VIII).

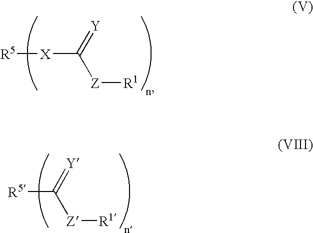

[In general formulas (V) and (VIII), R¹ and R^{1′} each independently denote an alkyl group, X denotes NR², a sulfur atom, or CR³R⁴, R², R³, and R⁴ each independently denote a hydrogen atom or a monovalent substituent, Y, Y′, Z, and Z′ each independently denote an oxygen atom or a sulfur atom, R⁵ and R^{5′} each independently denote an alkyl group, alkenyl group, alkynyl group, aryl group, heterocyclic group, cyano group, carboxyl group, sulfamoyl group, sulfo group, alkyl or arylsulfinyl group, alkyl or arylsulfonyl group, acyl group, aryloxycarbonyl group, alkoxycarbonyl group, carbamoyl group, phosphino group, phosphinyl group, phosphinyloxy group, phosphinylamino group, or silyl group, n and n′ each independently denote an integer ranging from 1 to 6.]

The above compound may have a thermal decomposition temperature ranging from 150 to 250° C.

Another aspect of the present invention relates to a method of recording information on the recording layer comprised in the above optical information recording medium by irradiation of a laser beam onto the optical information recording medium.

In the above method, the dye comprised in the recording layer may absorb the laser beam irradiated to generate heat, the compound comprised in the recording layer may decompose by the heat generated by the dye to produce a gas, and the information may be recorded through void generation in the recording layer by the gas produced.

The above laser beam may have a wavelength ranging from 390 to 440 nm.

A further aspect of the present invention relates to a method of using a compound comprising a substituent having a property of producing a gas by thermal decomposition as an additive in a solution comprising a dye.

The above solution may be a coating liquid for forming a recording layer of an optical information recording medium.

The above substituent may be denoted by general formula (I) or (VII).

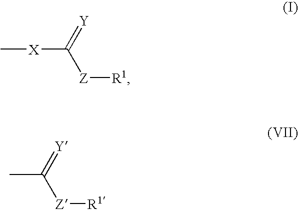

[In general formulas (I) and (VII), R¹ and R^{1′} each independently denote an alkyl group, X denotes NR², a sulfur atom, or CR³R⁴, R², R³, and R⁴ each independently denote a hydrogen atom or a monovalent substituent, Y, Y′, Z, and Z′ each independently denote an oxygen atom or a sulfur atom.]

X in general formula (I) may denote NR².

The above compound may be a compound denoted by general formula (V) or (VIII).

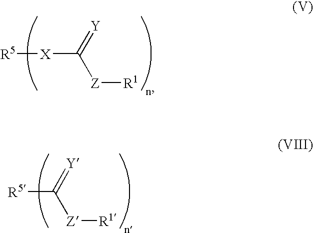

[In general formulas (V) and (VIII), R¹ and R^{1′} each independently denote an alkyl group, X denotes NR², a sulfur atom, or CR³R⁴, R², R³, and R⁴ each independently denote a hydrogen atom or a monovalent substituent, Y, Y′, Z, and Z′ each independently denote an oxygen atom or a sulfur atom, R⁵ and R^{5′} each independently denote an alkyl group, alkenyl group, alkynyl group, aryl group, heterocyclic group, cyano group, carboxyl group, sulfamoyl group, sulfo group, alkyl or arylsulfinyl group, alkyl or arylsulfonyl group, acyl group, aryloxycarbonyl group, alkoxycarbonyl group, carbamoyl group, phosphino group, phosphinyl group, phosphinyloxy group, phosphinylamino group, or silyl group, n and n′ each independently denote an integer ranging from 1 to 6.]

The present invention can provide an optical information recording medium with excellent recording characteristics in the short wavelength range.

Furthermore, according to the present invention, it is possible to increase the light-toughness of dyes by adding a compound comprising a substituent generating a gas by thermal decomposition to the dye-containing solution.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 is a schematic sectional view of an example of the optical information recording medium of the present invention.

FIG. 2 is a schematic sectional view of an example of the optical information recording medium of the present invention.

Explanations of symbols in the drawings are as follows:
10A First optical information recording medium
10B Second optical information recording medium
12 First support
14 First recordable recording layer
16 Cover layer
18 First light reflective layer
20 Barrier layer
22 First bonding layer
24 Second support
26 Second recordable recording layer
28 Protective support
30 Second light reflective layer
32 Second bonding layer
44 Hard coat layer

### DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Optical Information Recording Medium

The optical information recording layer of the present invention comprises a recording layer comprising a dye on a support. The recording layer further comprises a compound comprising a substituent having a property of producing a gas by thermal decomposition. Incorporating the above compound into the recording layer permits the formation of voids in pits through the generation of gas when the compound is thermally decomposed during recording. Although varying with the dye employed in the recording layer, the refractive index of portions that have not been irradiated by the laser beam in the recording layer is generally 1.6 to 1.9, for example. By contrast, the refractive index of portions in which voids have been formed by irradiation of a laser beam is about 1.0, constituting a large difference in refractive index relative to portions that have not been irradiated. In the present invention, the incorporating of a compound comprising a substituent having a property of producing a gas by thermal decomposition into the recording layer can achieve a large difference in refractive index, thereby permitting increased recording characteristics. The above compound will be described in detail further below.

### Dye in Recording Layer

In the present invention, the laser beam used to record information in the optical information recording medium is preferably a laser beam in the near infrared region (normally a laser beam with a wavelength around 780 nm), a visible laser beam (with a wavelength of 630 to 680 nm), and a laser beam with a wavelength of equal to or lower than 530 nm (for example, blue laser with a wavelength of 405 nm). A visible laser beam (with a wavelength of 630 to 680 nm) or a laser beam with a wavelength of equal to or lower than 530 nm (such as a blue laser of 405 nm) is preferred. A laser beam with a wavelength of 390 to 440 nm (such as a blue laser of 405 nm) is of even greater preference.

A dye having absorption for the laser beam that is irradiated to record information can be employed as the dye in the recording layer. The dye is preferably one that generates heat through absorption of the recording laser beam. In the present invention, it is preferable for the dye comprised in the recording layer to generate heat when irradiated by a laser beam, and for the substituent comprised in the compound to be thermally decomposed by the heat thus generated, thereby producing a gas that forms voids (pits) in the recording layer. In the present invention, the term “having absorption” means having a molar absorption coefficient ε(epsilon) (L/(mole·cm)) that is equal to or greater than 5,000. The dye employed in the recording layer preferably has a maximum absorption wavelength falling within a range of 300 to 900 nm and a molar absorption coefficient ε(L/(mole·cm)) for the laser beam that is irradiated to record information that is equal to or greater than 5,000, more preferably a maximum absorption wavelength falling within a range of 350 to 500 nm, and further preferably, a maximum absorption wavelength falling within a range of 370 to 460 nm. The molar absorption coefficient ε(L/(mole·cm)) for the laser beam that is irradiated to record information is more preferably equal to or greater than 10,000, further preferably equal to or greater than 15,000. The upper limit of the molar absorption coefficient ε(L/(mole·cm)) is not specifically limited, and may be 1,000,000, for example.

The dye employed in the recording layer may be suitably selected in consideration of its capacity to absorb the laser beam that is irradiated to record information. Specific examples of the dye employed in the recording layer are: oxonol dyes, cyanine dyes, styryl dyes, merocyanine dyes, phthalocyanine dyes, triazine dyes, benzotriazole dyes, benzooxazole dyes, aminobutadiene, azo dyes, azomethine dyes, pyridoporphyrazine dyes, pyradoporphyrazine dyes, porphyrin dyes, porphyrazine dyes, and diketopyrrolopyrrole dyes. Phthalocyanine dyes, triazine dyes, benzotriazole dyes, azo dyes, and cyanine dyes are preferably employed, and phthalocyanine dyes, triazine dyes, azo dyes, and cyanine dyes are further preferably employed.

The phthalocyanine derivative denoted by general formula (1) below is preferably employed as the phthalocyanine dye.

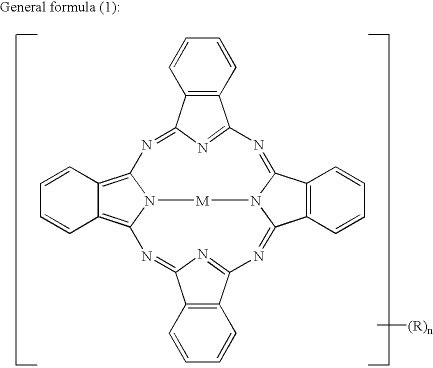

In general formula (1), R denotes a substituent. Examples of such a substituent are the substituents given by way of example for R^{α1} to R^{α8} and R^{β1} to R^{62 8} in general formula (2) further below.

n denotes an integer ranging from 1 to 8, preferably 1 to 6, and more preferably, 1 to 4. When n is an integer of equal to or greater than 2, plural Rs may be identical or different from each other.

M denotes two hydrogen atoms, a bivalent to tetravalent metal atom, a bivalent to tetravalent oxymetal atom, or a bivalent to tetravalent metal atom having a ligand. Specific examples and preferable examples are as described further below for general formula (2).

A preferable embodiment of the phthalocyanine derivative denoted by general formula (1) is the phthalocyanine derivative denoted by general formula (2) below.

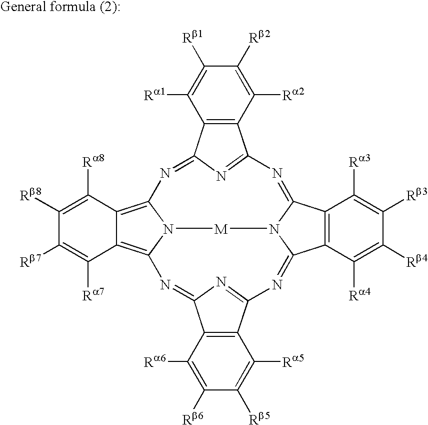

In general formula (2), R^{α1} to R^{α8} and R^{β1} to R^{β8} each independently denote a hydrogen atom or a substituent. At least eight from among R^{α1} to R^{α8} and R^{β1} to R^{β8} denote hydrogen atoms. Examples of the substituents are: halogen atoms, cyano groups, nitro groups, formyl groups, carboxyl groups, sulfo groups, substituted or unsubstituted alkyl groups having 1 to 20 carbon atoms, substituted or unsubstituted aryl groups having 6 to 14 carbon atoms, substituted or unsubstituted heterocyclic groups having 1 to 10 carbon atoms, substituted or unsubstituted alkoxy groups having 1 to 20 carbon atoms, substituted or unsubstituted aryloxy groups having 6 to 14 carbon atoms, substituted or unsubstituted acyl groups having 2 to 21 carbon atoms, substituted or unsubstituted alkylsulfonyl groups having 1 to 20 carbon atoms, substituted or unsubstituted arylsulfonyl groups having 6 to 14 carbon atoms, heterylsulfonyl groups having 1 to 10 carbon atoms, substituted or unsubstituted carbamoyl groups having 1 to 25 carbon atoms, substituted or unsubstituted sulfamoyl groups having 0 to 32 carbon atoms, substituted or unsubstituted alkoxycarbonyl groups having 2 to 20 carbon atoms, substituted or unsubstituted aryloxycarbonyl groups having 7 to 15 carbon atoms, substituted or unsubstituted acylamino groups having 2 to 21 carbon atoms, substituted or unsubstituted sulfonylamino groups having 1 to 20 carbon atoms, and substituted or unsubstituted amino groups having 0 to 36 carbon atoms. In general formula (2), not all of R^{α1} to R^{α8} denote hydrogen atoms. M denotes two hydrogen atoms, a bivalent to tetravalent metal atom, a bivalent to tetravalent oxymetal atom, or a bivalent to tetravalent metal atom having a ligand.

Each of R^{α1} to R^{α8} and R^{β1} to R^{β8} in general formula (2) independently preferably denotes a hydrogen atom, a halogen atom, carboxyl group, sulfo group, substituted or unsubstituted alkyl group having 1 to 16 carbon atoms (such as a methyl group, ethyl group, n-propyl group, or i-propyl group), substituted or unsubstituted aryl group having 6 to 14 carbon atoms (such as a phenyl group, p-methoxyphenyl group, or p-octadecylphenyl group), substituted or unsubstituted alkoxy group having 1 to 16 carbon atoms (such as a methoxy group, ethoxy group, or n-octyloxy group), substituted or unsubstituted aryloxy group having 6 to 10 carbon atoms (such as a phenoxy group or p-ethoxyphenoxy group), substituted or unsubstituted alkylsulfonyl group having 1 to 20 carbon atoms (such as a methanesulfonyl group, n-propylsulfonyl group, or n-octylsulfonyl group), substituted or unsubstituted arylsulfonyl group having 6 to 14 carbon atoms (such as a toluenesulfonyl group or benzenesulfonyl group), substituted or unsubstituted sulfamoyl group having 0 to 20 carbon atoms (such as a methylsulfamoyl group or n-butylsulfamoyl group), alkoxycarbonyl group having 1 to 17 carbon atoms (such as a methoxycarbonyl group or n-butoxycarbonyl group), substituted or unsubstituted aryloxycarbonyl group having 7 to 15 carbon atoms (such as a phenoxycarbonyl group or m-chlorophenylcarbonyl group), substituted or unsubstituted acylamino group having 2 to 21 carbon atoms (such as an acetylamino group, pivaloylamino group, or n-hexylamino group), or sulfonylamino group having 1 to 18 carbon atoms (such as a methanesulfonylamino group or n-butanesulfonylamino group).

R^{α1} to R^{α8} and R^{β1} to R^{β8} more preferably denote hydrogen atoms, halogen atoms, carboxyl groups, sulfo groups, substituted or unsubstituted alkyl groups having 1 to 16 carbon atoms, substituted or unsubstituted alkoxy groups having 1 to 16 carbon atoms, substituted or unsubstituted alkylsulfonyl groups having 1 to 20 carbon atoms, substituted or unsubstituted arylsulfonyl groups having 6 to 14 carbon atoms, substituted or unsubstituted sulfamoyl groups having 2 to 20 carbon atoms, alkoxycarbonyl groups having 1 to 13 carbon atoms, substituted or unsubstituted acylamino groups having 2 to 21 carbon atoms, or sulfonylamino groups having 1 to 18 carbon atoms.

Further preferably, R^{α1} to R^{α8} denote hydrogen atoms, halogen atoms, sulfo groups, substituted or unsubstituted alkoxy groups having 1 to 16 carbon atoms, substituted or unsubstituted alkylsulfonyl groups having 1 to 20 carbon atoms, substituted or unsubstituted arylsulfonyl groups having 6 to 14 carbon atoms, substituted or unsubstituted sulfamoyl groups having 2 to 20 carbon atoms, substituted or unsubstituted acylamino groups having 2 to 21 carbon atoms, or sulfonylamino groups having 1 to 18 carbon atoms, with R^{β1} to R^{β8} denoting hydrogen atoms or halogen atoms.

Still more preferably, R^{α1} to R^{α8} denote hydrogen atoms, sulfo groups, unsubstituted alkylsulfonyl groups having 1 to 20 carbon atoms, unsubstituted arylsulfonyl groups having 6 to 14 carbon atoms, or unsubstituted sulfamoyl groups having 7 to 20 carbon atoms, with R^{β1} to R^{β8} denoting hydrogen atoms.

One from among R^{α1} and R^{α2} in the phthalocyanine derivative denoted by general formula (2), one from among R^{α3} and R^{α4}, one from among R^{α5} and R^{α6}, and one from among R^{α7} and R^{α8}—a total of four—preferably do not simultaneously denote hydrogen atoms.

In general formula (2), R^{α1} to R^{α8} and R^{β1} to R^{β8} may be further substituted; the following are examples of the substituents: chain or cyclic substituted or unsubstituted alkyl groups having 1 to 20 carbon atoms (such as methyl groups, ethyl groups, isopropyl groups, cyclohexyl groups, benzyl groups, and phenethyl groups), substituted or unsubstituted aryl groups having 6 to 18 carbon atoms (such as phenyl groups, chlorophenyl groups, 2,4-di-t-amylphenyl groups, and 1-naphthyl groups), substituted or unsubstituted alkenyl groups having 2 to 20 carbon atoms (such as vinyl groups and 2-methylvinyl groups), substituted or unsubstituted alkynyl groups having 2 to 20 carbon atoms (such as ethynyl groups, 2-methylethynyl groups, and 2-phenylethynyl groups), halogen atoms (such as F, Cl, Br, and I), cyano groups, hydroxy groups, carboxyl groups, substituted or unsubstituted acyl groups having 2 to 20 carbon atoms (such as acetyl groups, benzoyl groups, salicyloyl groups, and pivaloyl groups), substituted or unsubstituted alkoxy groups having 1 to 20 carbon atoms (such as methoxy groups, butoxy groups, cyclohexyloxy groups), substituted or unsubstituted aryloxy groups having 6 to 20 carbon atoms (such as phenoxy groups, 1-naphthoxy groups, and p-methoxyphenoxy groups), substituted or unsubstituted alkylthio groups having 1 to 20 carbon atoms (such as methylthio groups, butylthio groups, benzylthio groups, and 3-methoxypropylthio groups), substituted or unsubstituted arylthio groups having 6 to 20 carbon atoms (such as phenylthio groups and 4-chlorophenylthio groups), substituted or unsubstituted alkylsulfonyl groups having 1 to 20 carbon atoms (such as methanesulfonyl groups and butanesulfonyl groups), substituted or unsubstituted arylsulfonyl groups having 6 to 20 carbon atoms (such as benzenesulfonyl groups and paratoluenesulfonyl groups), substituted or unsubstituted carbamoyl groups having 1 to 17 carbon atoms (such as unsubstituted carbamoyl groups, methylcarbamoyl groups, ethylcarbamoyl groups, n-butylcarbamoyl groups, and dimethylcarbamoyl groups), substituted or unsubstituted acylamino groups having 1 to 16 carbon atoms (such as acetylamino groups and benzoylamino groups), substituted or unsubstituted acyloxy groups having 2 to 10 carbon atoms (such as acetoxy groups and benzoyloxy groups), substituted or unsubstituted alkoxycarbonyl groups having 2 to 10 carbon atoms (such as methoxycarbonyl groups and ethoxycarbonyl groups), and five or six-membered substituted or unsubstituted heterocyclic groups (such as aromatic heterocyclic groups such as pyridyl groups, thienyl groups, furyl groups, thiazolyl groups, imidazolyl groups, and pyrazolyl groups, and nonaromatic heterocyclic groups such as pyrrolidine rings, piperidine rings, morpholino rings, pyran rings, thiopyran rings, dioxane rings, and dithiolane rings).

In general formula (2), preferable substituents on R^{α1} to R^{α8} and R^{β1} to R^{β8} are: chain or cyclic substituted or unsubstituted alkyl groups having 1 to 16 carbon atoms, aryl groups having 6 to 14 carbon atoms, alkoxy groups having 1 to 16 carbon atoms, aryloxy groups having 6 to 14 carbon atoms, halogen atoms, alkoxycarbonyl groups having 2 to 17 carbon atoms, carbamoyl groups having 1 to 10 carbon atoms, and acylamino groups having 1 to 10 carbon atoms.

Of these, the preferred substituents are: chain or cyclic alkyl groups having 1 to 10 carbon atoms, aryl groups having 6 to 10 carbon atoms, alkoxy groups having 1 to 10 carbon atoms, aryloxy groups having 6 to 10 carbon atoms, chlorine atoms, alkoxycarbonyl groups having 2 to 11 carbon atoms, carbamoyl groups having 1 to 7 carbon atoms, and acylamino groups having 1 to 8 carbon atoms.

Of these, the substituents of even greater preference are: branched chain or cyclic unsubstituted alkyl groups having 1 to 8 carbon atoms, unsubstituted alkoxy groups having 1 to 8 carbon atoms, unsubstituted alkoxycarbonyl groups having 3 to 9 carbon atoms, phenyl groups, and chlorine atoms. The substituent of greatest preference is an unsubstituted alkoxy group having 1 to 6 carbon atoms.

M denotes two hydrogen atoms, a bivalent to tetravalent metal atom, a bivalent to tetravalent oxymetal atom, or a bivalent to tetravalent metal atom having a ligand. Preferably, M denotes a bivalent to tetravalent metal atom, among which copper atoms, nickel atoms, and palladium atoms are preferred. Copper atoms or nickel atoms are of still greater preference, with copper atoms being of greatest preference.

The phthalocyanine derivative denoted by general formula (1) or (2) may be a mixture of isomers in which the substituents are substituted at different positions.

The phthalocyanine derivative is preferably a mixture of positional isomers in which the content of the component present in greatest quantity constitutes less than 50 weight percent of the total, more preferably one in which the content of the component present in greatest quantity constitutes equal to or less than 45 weight percent of the total, and further preferably, one in which the content of the component present in greatest quantity constitutes equal to or less than 40 weight percent of the total.

Specific examples of the phthalocyanine derivative suitable for use in the present invention are given below. However, the present invention is not limited to these examples.

Below, the notation “R^{α1}/R^{α2}” means either R^{α1} or R^{α2}. Accordingly, the compound thus denoted is a mixture of substitution-position isomers. In the case of no substitution—that is, when hydrogen atoms are substituted—the notation is omitted.

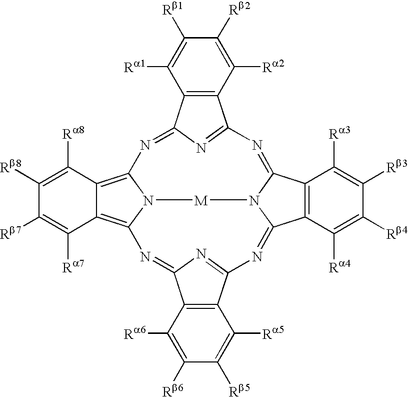

Specific examples of phthalocyanine derivative suitable for use in the present invention

| No. | Position and type of substituent | M |
|---|---|---|
| (I-1) | R^{α1}/R^{α2},R^{α3}/R^{α4},R^{α5}/R^{α6},R^{α7}/R^{α8} | Cu |
| | —SO₂N(C₅H₁₁-i)₂ | |
| (I-2) | R^{α1}/R^{α2},R^{α3}/R^{α4},R^{α5}/R^{α6},R^{α7}/R^{α8} | Cu |
| | —SO₂NH (2-s-butoxy-5- | |
| | t-amylphenyl) | |
| (I-3) | R^{α1}/R^{α2},R^{α3}/R^{α4},R^{α5}/R^{α6} | Cu |
| | —SO₂NH(CH₂)₃O (2,4-di-t-amyl- | |
| | phenyl) | |
| | R^{α7}/R^{α8}—SO₃H | |
| (I-4) | R^{α1}/R^{α2},R^{α3}/R^{α4},R^{α5}/R^{α6},R^{α7}/R^{α8} | Ni |
| | —SO₂N (3-methoxypropyl)₂ | |
| (I-5) | R^{α1}/R^{α2},R^{α3}/R^{α4},R^{α5}/R^{α6},R^{α7}/R^{α8} | Ni |
| | —SO₂NMe (cyclohexyl) | |
| (I-6) | R^{α1}/R^{α2},R^{α3}/R^{α4},R^{α5}/R^{α6},R^{α7}/R^{α8} | Ni |
| | —SO₂N (3-i-propoxyphenyl)₂ | |
| (I-7) | R^{α1}/R^{α2},R^{α3}/R^{α4},R^{α5}/R^{α6},R^{α7}/R^{α8} | Pd |
| | —SO₂NH (2-i-amyloxy- | |
| | carbonylphenyl) | |
| (I-8) | R^{α1}/R^{α2},R^{α3}/R^{α4},R^{α5}/R^{α6},R^{α7}/R^{α8} | Pd |
| | —SO₂NH (2,4,6-trimethyl- | |
| | phenyl) | |
| (I-9) | R^{α1}/R^{α2},R^{α3}/R^{α4},R^{α5}/R^{α6},R^{α7}/R^{α8} | Co |
| | —SO₂ (4-morpholino) | |
| (I-10) | R^{α1}/R^{α2},R^{α3}/R^{α4},R^{α5}/R^{α6},R^{α7}/R^{α8} | Fe |
| | —SO₂N(C₂H₅) (4-fluorophenyl) | |
| (I-11) | R^{α1}/R^{α2},R^{α3}/R^{α4},R^{α5}/R^{α6} | Cu |
| | —SO₂NH(CH₂)₃N(C₂H₅)₂ | |
| (I-12) | R^{α1}/R^{α2},R^{α3}/R^{α4},R^{α5}/R^{α6},R^{α7}/R^{α8} | Cu |
| | —SO₂ (2-n-propoxyphenyl) | |
| (I-13) | R^{α1}/R^{α2},R^{α3}/R^{α4},R^{α5}/R^{α6},R^{α7}/R^{α8} | Ni |
| | —SO₂ (2-n-butoxy-5-t-butyl- | |
| | phenyl) | |
| (I-14) | R^{α1}/R^{α2},R^{α3}/R^{α4},R^{α5}/R^{α6},R^{α7}/R^{α8} | Co |
| | —SO₂ (2-methoxycarbonyl- | |
| | phenyl) | |
| (I-15) | R^{α1}/R^{α2},R^{α3}/R^{α4},R^{α5}/R^{α6},R^{α7}/R^{α8} | Cu |
| | —SO₂(CH₂)₄O (2-chloro-4- | |
| | t-amylphenyl) | |
| (I-16) | R^{α1}/R^{α2},R^{α3}/R^{α4},R^{α5}/R^{α6},R^{α7}/R^{α8} | Pd |
| | —SO₂(CH₂)₂CO₂C₄H₉-i | |
| (I-17) | R^{α1}/R^{α2},R^{α3}/R^{α4},R^{α5}/R^{α6},R^{α7}/R^{α8} | Cu |
| | —SO₂ (cyclohexyl) | |
| (I-18) | R^{α1}/R^{α2},R^{α3}/R^{α4},R^{α5}/R^{α6},R^{α7}/R^{α8} | Ni |
| | —SO₂ {4-(2-s-butoxy- | |
| | benzoylamino) phenyl} | |
| (I-19) | R^{α1}/R^{α2},R^{α3}/R^{α4},R^{α5}/R^{α6} | Pd |
| | —SO₂ (2,6-dichloro- | |
| | 4-methoxyphenyl) | |
| (I-20) | R^{α1}/R^{α2},R^{α3}/R^{α4},R^{α5}/R^{α6} | Mg |
| | —SO₂CH(Me)CO₂CH₂—CH(C₂H₅)C₄H₉-n | |
| (I-21) | R^{α1}/R^{α2},R^{α3}/R^{α4},R^{α5}/R^{α6},R^{α7}/R^{α8} | Zn |
| | —SO₂ {2-(2-ethoxyethoxy)- | |
| | phenyl} | |
| | R^{β1}/R^{β2},R^{β3}/R^{β4},R^{β5}/R^{β6},R^{β7}/R^{β8} | |
| | —C₂H₅ | |
| (I-22) | R^{α1}/R^{α2},R^{α3}/R^{α4},R^{α5}/R^{α6},R^{α7}/R^{α8} | Cu |
| | —SO₂N(CH₂CH₂OMe)₂ | |
| (I-23) | R^{α1}/R^{α2},R^{α3}/R^{α4},R^{α5}/R^{α6},R^{α7}/R^{α8} | Ni |
| | —OCH₂CH(C₂H₅)C₄H₉-n | |
| (I-24) | R^{α1}/R^{α2},R^{α3}/R^{α4},R^{α5}/R^{α6},R^{α7}/R^{α8} | Zn |
| | —OCHMe (phenyl) | |
| (I-25) | R^{α1},R^{α2},R^{α3},R^{α4},R^{α5},R^{α6},R^{α7},R^{α8} | Cu |
| | —OCH (s-butyl)₂ | |
| (I-26) | R^{α1},R^{α2},R^{α3},R^{α4},R^{α5},R^{α6},R^{α7},R^{α8} | SiCl₂ |
| | —OCH₂CH₂OC₃H₇-i | |
| (I-27) | R^{α1}/R^{α2},R^{α3}/R^{α4},R^{α5}/R^{α6},R^{α7}/R^{α8}- | Ni |
| | t-amyl | |
| | R^{β1}/R^{β2},R^{β3}/R^{β4},R^{β5}/R^{β6},R^{β7}/R^{β8} | |
| | —Cl | |
| (I-28) | R^{α1}/R^{α2},R^{α3}/R^{α4},R^{α5}/R^{α6},R^{α7}/R^{α8}- | Zn |
| | (2,6-di-ethoxyphenyl) | |
| (I-29) | R^{α1}/R^{α2},R^{α3}/R^{α4},R^{α5}/R^{α6} | Cu |
| | —SO₂NHCH₂CH₂OC₃H₇-i | |
| | R^{α7}/R^{α8}—SO₃H | |
| (I-30) | R^{α1}/R^{α2},R^{α3}/R^{α4},R^{α5}/R^{α6} | Cu |
| | —CO₂CH₂CH₂OC₂H₅ | |
| | R^{α7}/R^{α8}—CO₂H | |
| (I-31) | R^{α1}/R^{α2},R^{α3}/R^{α4},R^{α5}/R^{α6},R^{α7}/R^{α8} | Co |
| | —CO₂CH(Me)CO₂C₃H₇-i | |
| (I-32) | R^{α1}/R^{α2},R^{α3}/R^{α4},R^{α5}/R^{α6},R^{α7}/R^{α8} | Cu |
| | —CONHCH₂CH₂OC₃H₇-i | |
| (I-33) | R^{α1}/R^{α2},R^{α3}/R^{α4},R^{α5}/R^{α6} | Pd |
| | —CON(CH₂CH₂OC₄H₉-n)₂ | |
| | R^{α7}/R^{α8}—CO₂H | |
| (I-34) | R^{α1}/R^{α2},R^{α3}/R^{α4},R^{α5}/R^{α6},R^{α7}/R^{α8} | Co |
| | —NHCOCH(C₂H₅)C₄H₉-n | |
| (I-35) | R^{α1}/R^{α2},R^{α3}/R^{α4},R^{α5}/R^{α6},R^{α7}/R^{α8} | Mg |
| | —NHCO (2-n-butoxycarbonyl- | |
| | phenyl) | |
| (I-36) | R^{α1}/R^{α2},R^{α3}/R^{α4},R^{α5}/R^{α6},R^{α7}/R^{α8} | Pd |
| | —NHSO₂ (2-i-propoxyphenyl) | |
| (I-37) | R^{α1}/R^{α2},R^{α3}/R^{α4},R^{α5}/R^{α6},R^{α7}/R^{α8} | Zn |
| | —NHSO₂ (2-n-butoxy-5-t-amyl- | |
| | phenyl) | |
| (I-38) | R^{α1}/R^{α2},R^{α3}/R^{α4},R^{α5}/R^{α6},R^{α7}/R^{α8} | Ni |
| | —SO₂CH₃ | |
| (I-39) | R^{α1}/R^{α2},R^{α3}/R^{α4},R^{α5}/R^{α6},R^{α7}/R^{α8} | Cu |
| | —SO₂CH(CH₃)₂ | |
| (I-40) | R^{α1}/R^{α2},R^{α3}/R^{α4},R^{α5}/R^{α6},R^{α7}/R^{α8} | Cu |
| | —SO₂C₄H₉-^{s} | |
| (I-41) | R^{α1}/R^{α2},R^{α3}/R^{α4},R^{α5}/R^{α6},R^{α7}/R^{α8} | Cu |
| | —SO₂CH₂CO₂CH(CH₃)₂ | |
| (I-42) | R^{α1}/R^{α2},R^{α3}/R^{α4},R^{α5}/R^{α6},R^{α7}/R^{α8} | Cu |
| | —SO₂CH(CH₃)CO₂CH₃ | |
| (I-43) | R^{α1}/R^{α2},R^{α3}/R^{α4},R^{α5}/R^{α6},R^{α7}/R^{α8} | Cu |
| | —SO₂C₆H₅ | |
| (I-44) | R^{α1}/R^{α2},R^{α3}/R^{α4},R^{α5}/R^{α6},R^{α7}/R^{α8} | Cu |
| | —SO₂N(C₅H₁₁⁻ⁱ)₂ | |
| (I-45) | R^{α1}/R^{α2},R^{α3}/R^{α4},R^{α5}/R^{α6},R^{α7}/R^{α8} | Cu |
| | —SO₂CH(CH₃)₂ | |

The above-described phthalocyanine derivatives may be synthesized by a known method and some of them can be obtained as a commercial product.

The triazine derivative denoted by general formula (3) below is desirable as a triazine dye for use as the recording layer dye.

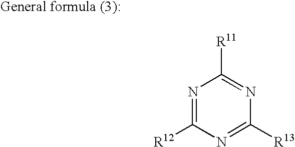

In general formula (3), R¹¹, R¹², and R¹³ each independently denote a hydrogen atom, alkyl group, alkenyl group, alkynyl group, aryl group, aralkyl group, or heterocyclic group.

In general formula (3), alkyl groups denoted by R¹¹, R¹², and R¹³ are preferably chain or cyclic optionally substituted alkyl groups having 1 to 20 carbon atoms (such as methyl groups, ethyl groups, n-propyl groups, isopropyl groups, n-butyl groups, isobutyl groups, sec-butyl groups, tert-butyl groups, methoxyethyl groups, hydroxyethyl groups, n-pentyl groups, isopentyl groups, and cyclohexyl groups), more preferably alkyl groups having 1 to 6 carbon atoms, and further preferably methyl groups, ethyl groups, n-propyl groups, n-butyl groups, and methoxyethyl groups.

In general formula (3), alkenyl groups denoted by R¹¹, R¹², and R¹³ preferably have 2 to 20 carbon atoms, more preferably 2 to 8 carbon atoms; examples are vinyl groups, 2-propenyl groups, 2-methylpropenyl groups, and 1,3-butadienyl groups.

In general formula (3), alkynyl groups denoted by R¹¹, R¹², and R¹³ preferably have 2 to 20 carbon atoms, more preferably 2 to 8 carbon atoms; examples are ethynyl groups, propynyl groups, and 3,3-dimethylbutynyl groups.

In general formula (3), aryl groups denoted by R¹¹, R ¹², and R¹³ are preferably optionally substituted aryl groups having 6 to 18 carbon atoms (such as phenyl groups, 1-naphthyl groups, 2-naphthyl groups, and 1-anthacenyl groups), more preferably phenyl groups, 1-naphthyl groups, or 2-naphthyl groups, and further preferably, phenyl groups.

In general formula (3), aralkyl groups denoted by R¹¹, R¹², and R¹³ are preferably optionally substituted aralkyl groups having 7 to 18 carbon atoms (such as benzyl groups, phenethyl groups, or anisyl groups), more preferably benzyl groups.

In general formula (3), heterocyclic groups denoted by R¹¹, R¹², and R¹³ are preferably five or six-membered saturated or unsaturated heterocyclic groups, preferably containing hetero atoms in the form of nitrogen atoms, oxygen atoms, or sulfur atoms and preferably containing 4 to 7 carbon atoms. Specific examples are 4-pyridyl groups, 2-pyridyl groups, 2-pyrazyl groups, 2-imidazolyl groups, 2-furtyl groups, 2-thiophenyl groups, 2-benzooxazolyl groups, and 2-benzothioxazolyl groups.

In general formula (3), R¹¹, R¹², and R¹³ preferably denote aryl groups or heterocyclic groups, with at least one from among R¹¹, R¹², and R¹³ preferably denoting an aryl group or heterocyclic group. Aryl groups are more preferable as R¹¹, R¹², and R¹³, with at least one from among R¹¹, R¹², and R¹³ more preferably denoting an aryl group, it being particularly preferable for all of R¹¹, R¹², and R¹³ to denote aryl groups.

Examples of substituents on R¹¹, R¹², and R¹³ in general formula (3) are given below: chain or cyclic alkyl groups having 1 to 20 carbon atoms (such as methyl groups, ethyl groups, n-propyl groups, isopropyl groups, and n-butyl groups), aryl groups having 6 to 18 carbon atoms (such as phenyl groups, chlorophenyl groups, anisyl groups, toluyl groups, 2,4-di-t-amyl groups, and 1-naphthyl groups), alkenyl groups having 2 to 20 carbon atoms (such as vinyl groups and 2-methylvinyl groups), alkynyl groups having 2 to 20 carbon atoms (such as ethynyl groups, 2-methylethynyl groups, and 2-phenylethynyl groups), halogen atoms (such as F, Cl, Br, and I), cyano groups, hydroxy groups, mercapto groups, substituted or unsubstituted amino groups having 0 to 20 carbon atoms, carboxy groups, formyl groups, acyl groups having 2 to 20 carbon atoms (such as acetyl groups, benzoyl groups, salicyloyl groups, and pivanoyl groups), alkoxy groups having 1 to 20 carbon atoms (such as methoxy groups, ethoxy groups, butoxy groups, and cyclohexyloxy groups), aryloxy groups having 6 to 18 carbon atoms (such as phenoxy groups and 1 naphthoxy groups), alkylthio groups having 1 to 20 carbon atoms (such as methylthio groups, butylthio groups, benzylthio groups, and 3-methoxypropylthio groups), arylthio groups having 6 to 18 carbon atoms (such as phenylthio groups and 4-chlorophenylthio groups), alkylsulfonyl groups having 1 to 20 carbon atoms (such as methanesulfonyl groups and butane sulfonyl groups), arylsulfonyl groups having 6 to 18 carbon atoms (such as benzenesulfonyl groups and paratoluenesulfonyl groups), carbamoyl groups having 1 to 10 carbon atoms, amido groups having 1 to 10 carbon atoms, imido groups having 2 to 12 carbon atoms, acyloxy groups having 2 to 10 carbon atoms, alkoxycarbonyl groups having 2 to 10 carbon atoms, and heterocyclic groups (such as aromatic heterocycles such as pyridyl groups, thienyl groups, furyl groups, thiazolyl groups, imidazolyl groups, pyrazolyl groups, and aliphatic heterocycles such as pyrrolidine rings, piperidine rings, morpholine rings, pyran rings, thiopyran rings, dioxane rings, and dithiolane rings).

Hydroxy groups, alkoxy groups, aryloxy groups, amino groups acylamino groups, sulfonylamino groups, mercapto groups, alkylthio groups, and arylthio groups are preferable as the above substituents. Hydroxy groups, alkoxy groups having 1 to 12 carbon atoms, aryloxy groups having 6 to 10 carbon atoms, amino groups having 1 to 12 carbon atoms, and acylamino groups having 2 to 13 carbon atoms are more preferable. Hydroxy groups are of still greater preference.

It is particularly preferable for a triazine derivative denoted by general formula (3) to have the structure denoted by general formula (4) below.

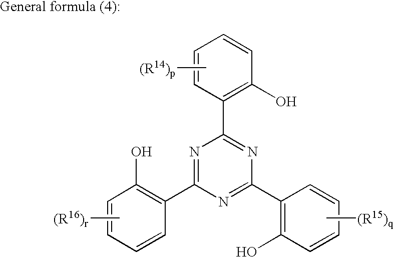

In general formula (4), R¹⁴, R¹⁵, and R¹⁶ each independently denote a monovalent substituent and p, q, and r each independently denote an integer ranging from 0 to 4.

The examples given as substituents on R¹¹, R¹², and R¹³ in general formula (3) are examples of the substituents denoted by R¹⁴, R¹⁵, and R¹⁶ in general formula (4). Alkyl groups having 1 to 6 carbon atoms (particularly methyl groups, ethyl groups, n-propyl groups, n-butyl groups, and t-butyl groups), aryl groups having 6 to 10 carbon atoms (particularly phenyl groups), alkoxy groups having 1 to 10 carbon atoms (particularly methoxy groups, ethoxy groups, n-butoxy groups, s-butoxy groups, and i-butoxy groups), aryloxy groups (particularly phenoxy groups), and halogen atoms (particularly chlorine atoms) are preferable, with alkoxy groups having 1 to 8 carbon atoms being further preferable.

In general formula (4), each of p, q, and r preferably independently denotes the integer 0, 1, or 2, with 1 and 2 being further preferable. When p denotes an integer of equal to or greater than 2, plural R¹⁴s may be identical or different from each other. When q denotes an integer of equal to or greater than 2, plural R¹⁵s may be identical or different from each other. When r denotes an integer of equal to or greater than 2, plural R¹⁶s may be identical or different from each other.

The compound denoted by general formula (4) may be bonded at any position to form a polymer. In such cases, the individual units may be identical or different from each other, and may be bonded to polymer chains such as polystyrene, polymethacrylate, polyvinylalcohol, or cellulose.

Specific preferable examples of the compound denoted by general formula (4) are given below. However, the present invention is not limited to these examples.

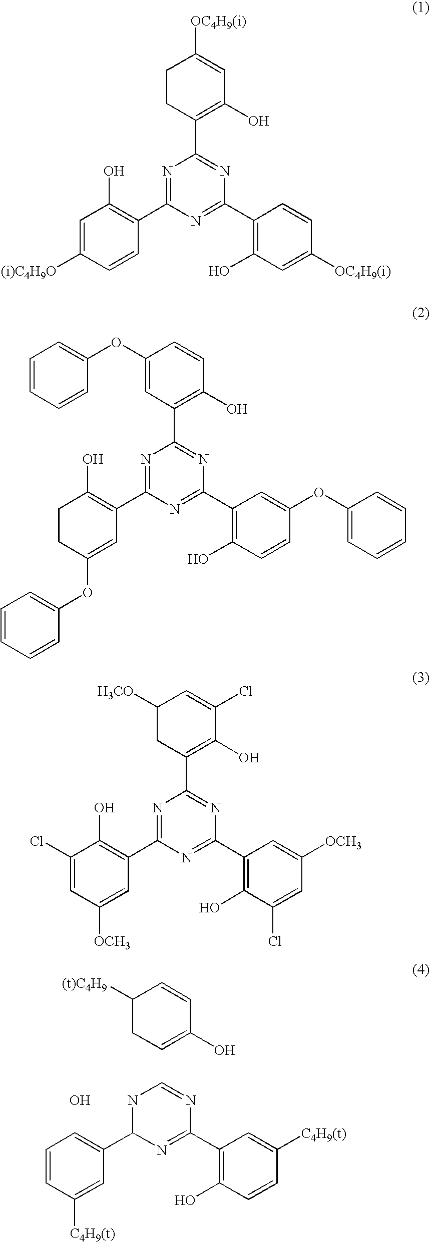

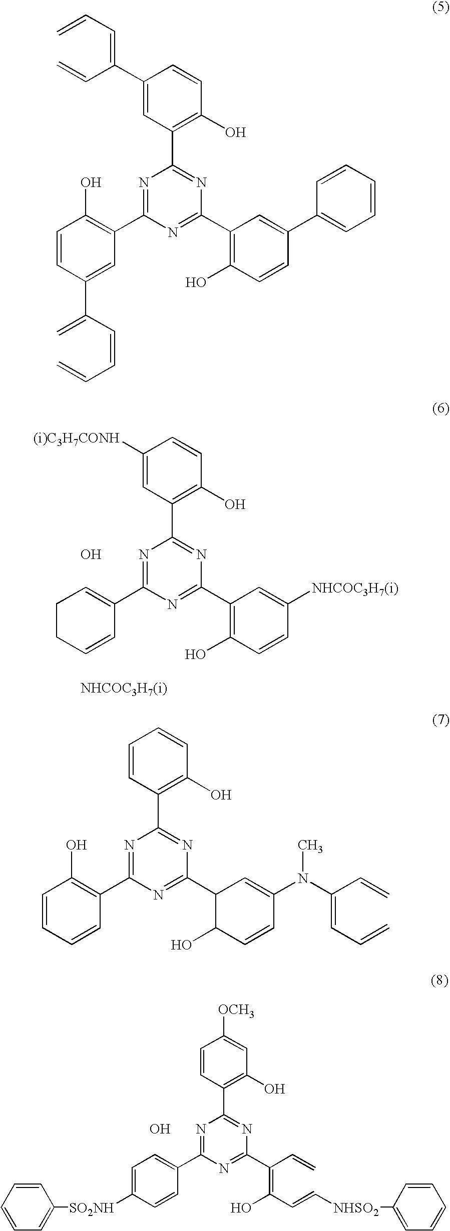

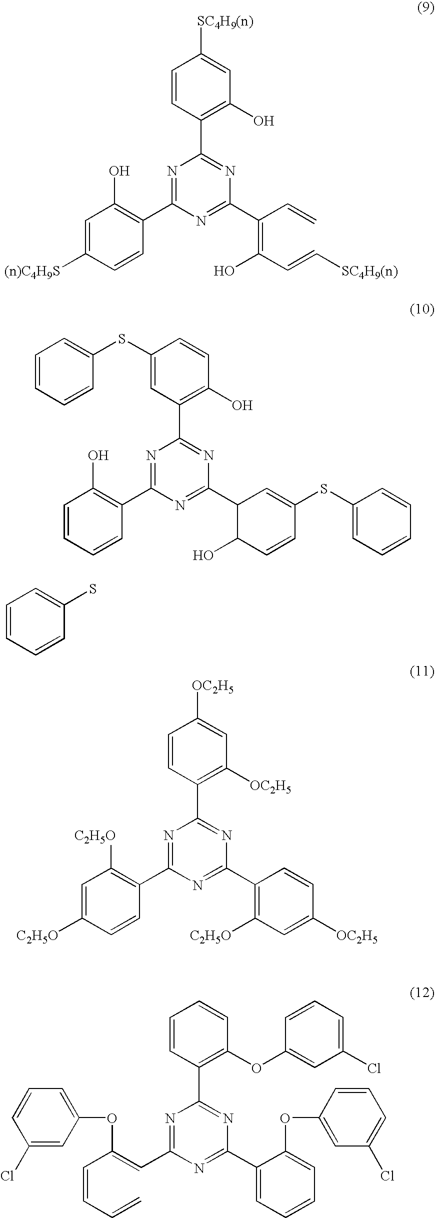

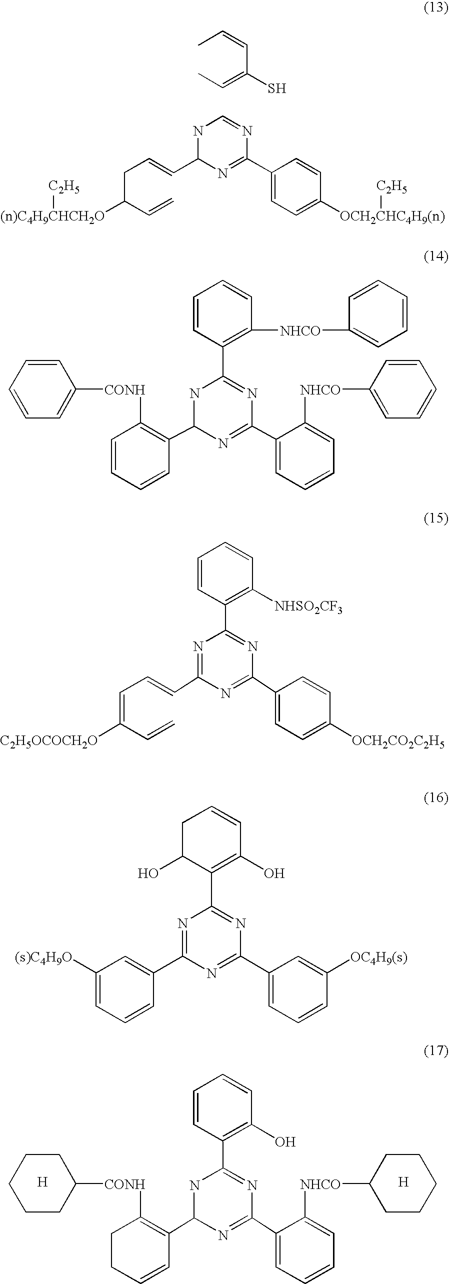

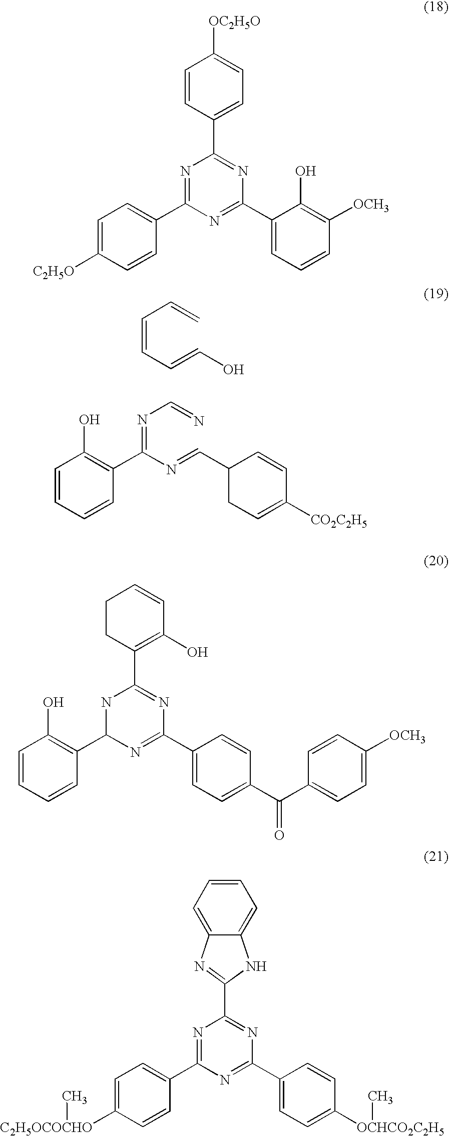

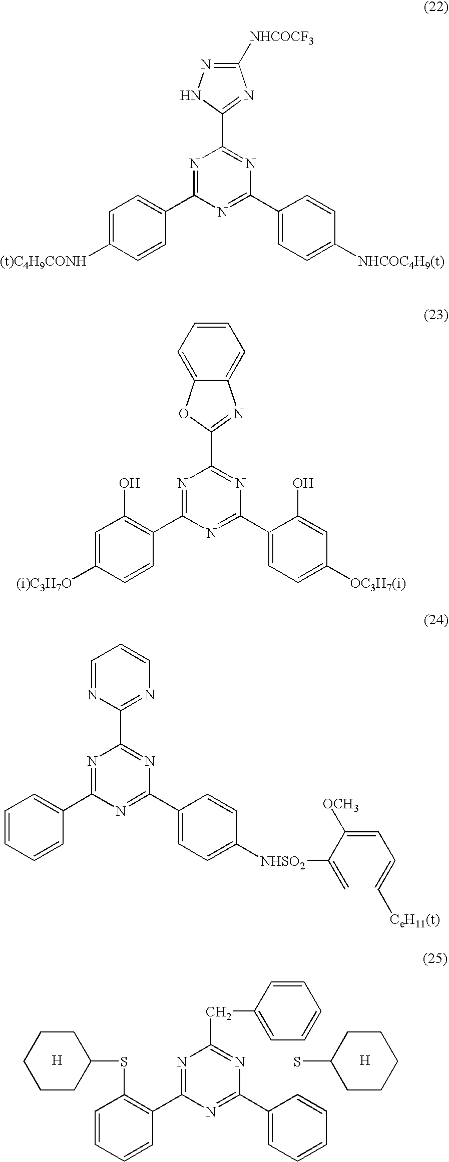

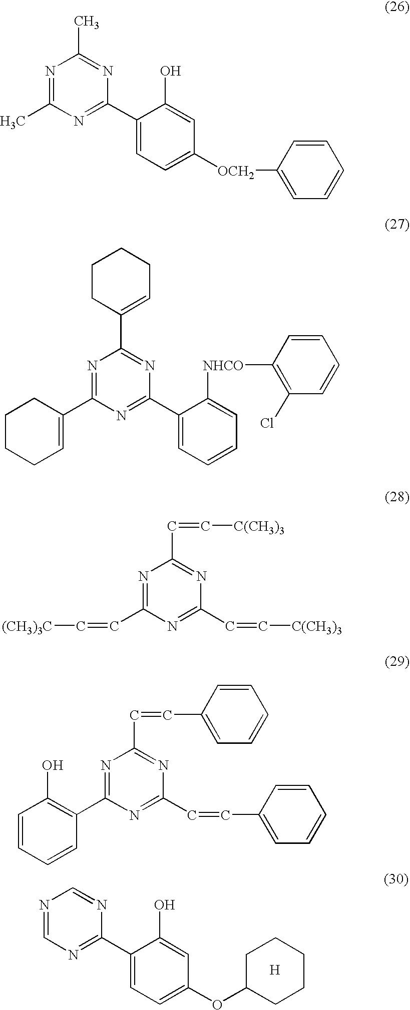

The above triazine derivatives can be synthesized by the methods described in German Patent Nos. 19,750,906 and 4,340,725; European Patent No. 531,258; and Japanese Unexamined Patent Publication (KOKAI) Heisei Nos. 7-188188, 7-188189, and 7-188190, which are expressly incorporated herein by reference in their entirety.

In the present invention, dyes in the form of the above-described phthalocyanine derivatives, triazine derivatives, and the like may be employed singly or in combinations of two or more. For example, the cyanine dyes described in Japanese Unexamined Patent Publication (KOKAI) No. 2001-232945 and WO01/044374, which are expressly incorporated herein by reference in their entirety, may also be employed.

The quantity of dye employed in the recording layer can fall within a range of 1.00 to 99.9 weight percent, for example; preferably 25.0 to 99.5 weight percent; and more preferably within a range of 50.0 to 99.0 weight percent, of the total weight of the recording layer.

Compound Comprising Substituent having Property of Producing Gas by Thermal Decomposition

The optical information recording medium of the present invention comprises a compound comprising a substituent having a property of producing a gas by thermal decomposition together with a dye in the recording layer. The above compound preferably has no absorption for the laser beam irradiated onto the optical information recording medium to record information, the absorption being such that it does not interfere with the functioning of the dye component. It is more preferably a colorless compound, or infrared dye, that has no absorption in the visible range. The term “having no absorption” means that the molar absorption coefficient ε(L/(mole·cm)) is less than 5,000.

The substituents denoted by general formulas (I), (VII), (IX), and (X) below are examples of the substituent having a property of producing a gas by thermal decomposition. However, the present invention is not limited to these examples.

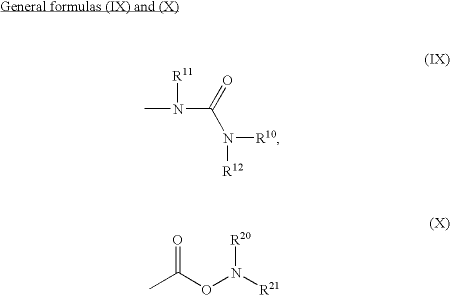

In general formulas (IX) and (X), R¹⁰ and R²⁰ each independently denote an alkyl group, and R¹¹, R¹², and R²¹ each independently denote a hydrogen atom or a monovalent substituent. R¹⁰, R¹¹, and R¹² may be bonded together to form a ring, and R²⁰ and R²¹ may be bonded together to form a ring.

Each of R¹⁰ and R²⁰ independently denotes an alkyl group. Details of these alkyl groups such as specific examples and preferable examples are as set forth further below for R¹ in general formulas (I) and (VII).

Each of R¹¹, R¹², and R²¹ independently denotes a hydrogen atom or a monovalent substituent. Details of the monovalent substituent such as specific examples and preferable examples are as set forth further below for R², R³, and R⁴ in general formulas (I) and (VII). Further, R¹⁰, R¹¹, and R¹² in general Formula (IX) may be bonded together to form a ring, and R²⁰ and R²¹ in general formula (X) may be bonded together to form a ring.

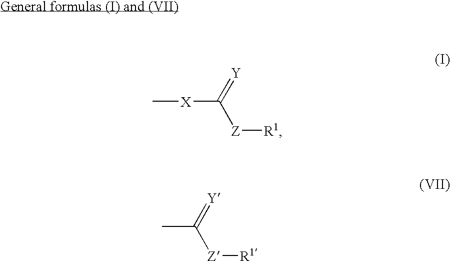

In general formulas (I) and (VII), R¹ and R^{1′} each independently denote an alkyl group. The alkyl group includes linear, branched chain, and cyclic substituted or unsubstituted alkyl groups, specific examples of which are: alkyl groups (preferably having 1 to 30 carbon atoms, such as methyl groups, ethyl groups, n-propyl groups, isopropyl groups, t-butyl groups, n-octyl groups, eicosyl groups, 2-chloroethyl groups, 2-cyanoethyl groups, and 2-ethylhexyl groups), and cycloalkyl groups (preferably substituted or unsubstituted cycloalkyl groups having 3 to 30 carbon atoms, such as cyclohexyl groups, cyclopentyl groups, and 4-n-dodecylcyclohexyl groups). The cycloalkyl groups include bicycloalkyl groups (preferably substituted or unsubstituted bicycloalkyl groups having 5 to 30 carbon atoms; that is, monovalent groups in which a hydrogen atom has been removed from a bicycloalkane having 5 to 30 carbon atoms, examples of which are bicyclo[1,2,2]heptane-2-yl and bicyclo[2,2,2]-octane-3-yl) and tricyclo structures comprising a greater number of rings. R¹ preferably denotes a cycloalkyl group or an alkyl group having 2 to 20 carbon atoms, more preferably a cycloalkyl group or a branched alkyl group having 3 to 20 carbon atoms.

In general formula (I), X denotes NR², a sulfur atom, an oxygen atom, or CR³R⁴. R², R³, and R⁴ each independently denote a hydrogen atom or a monovalent substituent. Examples of the substituents are substituted or unsubstituted alkyl groups (preferably having 1 to 20 carbon atoms, such as methyl groups, ethyl groups, n-propyl groups, isopropyl groups, n-butyl groups, n-pentyl groups, benzyl groups, 3-sulfopropyl groups, 4-sulfobutyl groups, 3-methyl-3-sulfopropyl groups, 2′-sulfobenzyl groups, carboxymethyl groups, and 5-carboxypentyl groups), substituted or unsubstituted alkenyl groups (preferably having 2 to 20 carbon atoms, such as vinyl groups and allyl groups), substituted or unsubstituted aryl groups (preferably having 6 to 20 carbon atoms, such as phenyl groups, 2-chlorophenyl groups, 4-methoxyphenyl groups, 3-methylphenyl groups, and 1-naphthyl groups), and substituted or unsubstituted heterocyclic groups (preferably having 1 to 20 carbon atoms, such as pyridyl groups, thienyl groups, furyl groups, thiazolyl groups, imidazolyl groups, pyrazolyl groups, pyrrolidino groups, piperidino groups, and morpholino groups). R², R³, and R⁴ preferably denote hydrogen atoms or substituted or unsubstituted alkyl groups, substituted or unsubstituted phenyl groups, or substituted or unsubstituted heterocyclic groups; more preferably hydrogen atoms, substituted or unsubstituted alkyl groups, or substituted or unsubstituted phenyl groups. In general formula (I), X preferably denotes NR².

In general formula (I), Y and Z each independently denote an oxygen atom or a sulfur atom. It is preferable for both Y and Z to denote an oxygen atom.

Details of Y′ and Z′ in general formula (VII) are as set forth in the description of Y and Z in general formula (I).

The above substituent is preferably a monovalent substituent denoted by general formula (I) or (VII), more preferably a monovalent substituent denoted by general formula (I). A preferable embodiment of the substituent denoted by general formula (I) is a monovalent substituent in which X denotes NR² and Y and Z both denote oxygen atoms in general formula (I), as shown in general formula (II) below.

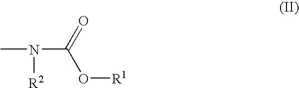

In general formula (II), R¹ and R² are identical to R¹ and R² in general formula (I).

A more preferable embodiment of the substituent denoted by general formula (I) is a monovalent substituent in which X denotes NR² (R² denoting a hydrogen atom) and Y and Z both denote oxygen atoms in general formula (I), as shown in general formula (III) below.

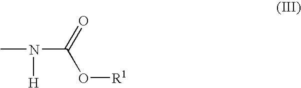

In general formula (III), R¹ is identical to R¹ in general formula (I).

An embodiment of the substituent denoted by general formula (I) of still greater preference is a monovalent substituent in which X denotes NR² (R² denoting a hydrogen atom), both Y and Z denote oxygen atoms, and R¹ denotes a t-butyl group in general formula (I), as shown in general formula (IV) below.

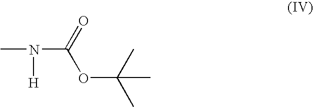

The compound comprising the substituent denoted by general formula (I) above can be the compound denoted by general formula (V) below. The compound comprising the substituent denoted by general formula (VII) above can be the compound denoted by general formula (VIII) below.

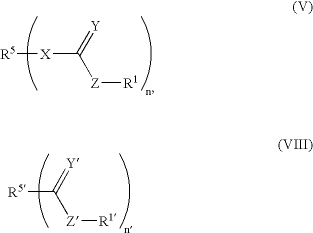

In general formulas (V) and (VIII), R⁵ and R^{5′} each independently denote an alkyl group, alkenyl group, alkynyl group, aryl group, heterocyclic group, cyano group, carboxyl group, sulfamoyl group, sulfo group, alkyl or arylsulfinyl group, alkyl or arylsulfonyl group, acyl group, aryloxycarbonyl group, alkoxycarbonyl group, carbamoyl group, phosphino group, phosphinyl group, phosphinyloxy group, phosphinylamino group, or silyl group.

Details of the various substituents denoted by R⁵ and R^{5′} in general formulas (V) and (VIII) are as follows.

The alkyl groups include linear, branched, and cyclic substituted and unsubstituted alkyl groups; specifically alkyl groups (preferably alkyl groups having 1 to 30 carbon atoms, such as methyl groups, ethyl groups, n-propyl groups, isopropyl groups, t-butyl groups, n-octyl groups, eicosyl groups, 2-chloroethyl groups, 2-cyanoethyl groups, and 2-ethylhexyl groups) and cycloalkyl groups (preferably substituted or unsubstituted cycloalkyl groups having 3 to 30 carbon atoms, such as cyclohexyl groups, cyclopentyl groups, and 4-n-dodecylcyclohexyl groups). The cycloalkyl groups include bicycloalkyl groups (preferably substituted or unsubstituted bicycloalkyl groups having 5 to 30 carbon atoms; that is, monovalent groups in which a hydrogen atom has been removed from a bicycloalkane having 5 to 30 carbon atoms, such as bicyclo[1,2,2]heptane-2-yl and bicyclo[2,2,2]-octane-3-yl) and tricyclo structures comprising a greater number of rings. The alkyl groups described hereinafter shall denote alkyl groups consistent with this concept.

The alkenyl group denotes a linear, branched, or cyclic substituted or unsubstituted alkenyl group. These include alkenyl groups (preferably substituted or unsubstituted alkenyl groups having 2 to 30 carbon atoms, such as vinyl groups, allyl groups, prenyl groups, geranyl groups, and oleyl groups) and cycloalkenyl groups (preferably substituted or unsubstituted cycloalkenyl groups having 3 to 30 carbon atoms; that is, monovalent groups in which a hydrogen atom has been removed from a cycloalkene having 3 to 30 carbon atoms, such as 2-cyclopentene-1-yl and 2-cyclohexene-1-yl). The cycloalkenyl groups include substituted and unsubstituted bicycloalkenyl groups. The bicycloalkenyl groups are preferably substituted or unsubstituted bicycloalkenyl groups having 5 to 30 carbon atoms; that is, monovalent groups in which a hydrogen atom in a bicycloalkene having a double bond has been removed, examples of which are bicyclo[2,2,1]hepto-2-ene-1-yl and bicyclo[2,2,2]octo-2-ene-4-yl. The alkenyl groups described hereinafter denote alkenyl groups consistent with this concept.

The alkynyl group is preferably a substituted or unsubstituted alkynyl group having 2 to 30 carbon atoms, such as an ethynyl group, propargyl group, or trimethylsilylethynyl group.

The aryl group is preferably a substituted or unsubstituted aryl group having 6 to 30 carbon atoms, such as a phenyl group, p-tolyl group, naphthyl group, m-chlorophenyl group, or o-hexadecanoylaminophenyl group.

The heterocyclic group is preferably a monovalent group in which a hydrogen atom has been removed from a five or six-membered, substituted or unsubstituted, aromatic or nonaromatic heterocyclic compound, more preferably a five or six-membered aromatic heterocyclic group having 3 to 30 carbon atoms, such as a 2-furyl group, 2-thienyl group, 2-pyrimidinyl group, or 2-benzothiazolyl group.

The sulfamoyl group is preferably a substituted or unsubstituted sulfamoyl group having 0 to 30 carbon atoms, such as an N-ethylsulfamoyl group, N-(3-dodecyloxypropyl)sulfamoyl group, N,N-dimethylsulfamoyl group, N-acetylsulfamoyl group, N-benzoylsulfamoyl group, or N-(N′-phenylcarbamoyl)sulfamoyl group.

The alkyl or arylsulfinyl group is preferably a substituted or unsubstituted alkylsulfinyl group having 1 to 30 carbon atoms or a substituted or unsubstituted arylsulfinyl group having 6 to 30 carbon atoms, such as a methylsulfinyl group, ethylsulfinyl group, phenylsulfinyl group, or p-methylphenylsulfinyl group.

The alkyl or arylsulfonyl group is preferably a substituted or unsubstituted alkylsulfonyl group having 1 to 30 carbon atoms, or a substituted or unsubstituted arylsulfonyl group having 6 to 30 carbon atoms, such as a methylsulfonyl group, ethylsulfonyl group, phenylsulfonyl group, or p-methylphenylsulfonyl group.

The acyl group is preferably a formyl group, substituted or unsubstituted alkylcarbonyl group having 2 to 30 carbon atoms, substituted or unsubstituted arylcarbonyl group having 7 to 30 carbon atoms, or substituted or unsubstituted heterocyclic carbonyl group having 4 to 30 carbon atoms with the bond to the carbonyl group being through a carbon atom, such as an acetyl group, pivaloyl group, 2-chloroacetyl group, stearoyl group, benzoyl group, p-n-octyloxyphenylcarbonyl group, 2-pyridylcarbonyl group, or 2-furylcarbonyl group.

The aryloxycarbonyl group is preferably a substituted or unsubstituted aryloxycarbonyl group having 7 to 30 carbon atoms, such as a phenoxycarbonyl group, o-chlorophenyloxycarbonyl group, m-nitrophenoxycarbonyl group, or p-t-butylphenoxycarbonyl group.

The alkoxycarbonyl group is preferably a substituted or unsubstituted alkoxycarbonyl group having 2 to 30 carbon atoms, such as a methoxycarbonyl group, ethoxycarbonyl group, t-butoxycarbonyl group, or n-octadecyloxycarbonyl group.

The carbamoyl group is preferably a substituted or unsubstituted carbamoyl having 1 to 30 carbon atoms, such as a carbamoyl group, N-methylcarbamoyl group, N,N-dimethylcarbamoyl group, N,N-di-n-octylcarbamoyl group, or N-(methylsulfonyl)carbamoyl group.

The silyl group is preferably a substituted or unsubstituted silyl group having 3 to 30 carbon atoms, such as a trimethylsilyl group, t-butyldimethylsilyl group, or phenyldimethylsilyl group.

In general formulas (V) and (VIII), n and n′ each independently denote an integer ranging from 1 to 6, preferably an integer ranging from 1 to 3, more preferably 1 or 2. When n and n′ denote integers of equal to or greater than 2, plural substituents denoted by general formulas (I) and (VII) may be identical or different from each other.

The compound denoted by general formula (V) is preferably the compound denoted by general formula (VI) below. The compound denoted by general formula (VIII) is preferably the compound denoted by general formula (XI) below.

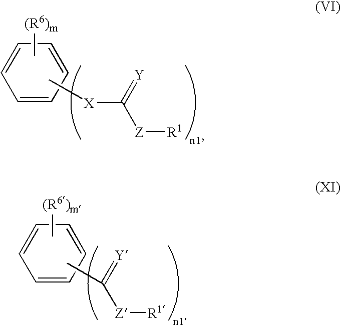

In general formulas (VI) and (XI), R⁶ and R^{6′} each independently denote a halogen atom, alkyl group, alkenyl group, alkynyl group, aryl group, heterocyclic group, cyano group, hydroxyl group, nitro group, carboxyl group, alkoxy group, aryloxy group, silyloxy group, heterocyclic oxy group, acyloxy group, carbamoyloxy group, alkoxycarbonyloxy group, aryloxycarbonyloxy group, amino group (including anilino groups), acylamino group, aminocarbonylamino group, alkoxycarbonylamino group, aryloxycarbonylamino group, sulfamoylamino group, alkyl or arylsulfonylamino group, mercapto group, alkylthio group, arylthio group, heterocyclic thio group, sulfamoyl group, sulfo group, alkyl or arylsulfinyl group, alkyl or arylsulfonyl group, acyl group, aryloxycarbonyl group, alkoxycarbonyl group, carbamoyl group, aryl or heterocyclic azo group, imido group, phosphino group, phosphinyl group, phosphinyloxy group, phosphinylamino group, silyl group, or boron group.

Details of various substituents denoted by R⁶ and R^{6′} in general formulas (VI) and (XI) will be described below. Examples of halogen atoms they may denote are chlorine, bromine, and iodine atoms.

The alkyl groups denote linear, branched, or cyclic substituted or unsubstituted alkyl groups, preferably alkyl groups having 1 to 30 carbon atoms (such as methyl groups, ethyl groups, n-propyl groups, isopropyl groups, t-butyl groups, n-octyl groups, eicosyl groups, 2-chloroethyl groups, 2-cyanoethyl groups, and 2-ethylhexyl groups) and cycloalkyl groups (preferably substituted or unsubstituted cycloalkyl groups having 3 to 30 carbon atoms, such as cyclohexyl groups, cyclopentyl groups, 4-n-dodecylcyclohexyl groups, and substituted or unsubstituted bicycloalkyl groups having 5 to 30 carbon atoms, that is, monovalent groups in which a hydrogen atom has been removed from a bicycloalkane having 5 to 30 carbon atoms, such as bicylo[1,2,2]heptane-2-yl and bicyclo[2,2,2]octane-3-yl).

The alkenyl groups denote linear, branched, or cyclic substituted or unsubstituted alkenyl groups, preferably substituted or unsubstituted alkenyl groups having 2 to 30 carbon atoms (such as vinyl groups, allyl groups, prenyl groups, geranyl groups, and oleyl groups) and cycloalkenyl groups (preferably substituted or unsubstituted cycloalkenyl groups having 3 to 30 carbon atoms, that is, monovalent groups in which a hydrogen atom has been removed from a cycloalkene having 3 to 30 carbon atoms, such as 2-cyclopentene-1-yl, 2-cyclohexene-1-yl, substituted or unsubstituted bicycloalkenyl groups having 5 to 30 carbon atoms, that is monovalent groups in which a hydrogen atom has been removed from a bicycloalkene having a double bond, such as bicyclo[2,2,1]hepto-2-ene-1-yl and bicyclo[2,2,2]octo-2-ene-4-yl).

The alkynyl groups preferably denote substituted or unsubstituted alkynyl groups having 2 to 30 carbon atoms, such as ethynyl groups, propargyl groups, and trimethylsilylethynyl groups.

The aryl groups preferably denote substituted or unsubstituted aryl groups having 6 to 30 carbon atoms, such as phenyl groups, p-tolyl groups, naphthyl groups, m-chlorophenyl groups, and o-hexadecanoylaminophenyl groups.

The heterocyclic groups preferably denote monovalent groups in which a hydrogen atom has been removed from a five or six-membered, substituted or unsubstituted, aromatic or nonaromatic heterocyclic compound, more preferably five or six-membered aromatic heterocyclic groups having 3 to 30 carbon atoms, such as 2-furyl groups, 2-thienyl groups, 2-pyrimidinyl groups, and 2-benzothiazolyl groups.

The alkoxy groups preferably denote substituted or unsubstituted alkoxy groups having 1 to 30 carbon atoms, such as methoxy groups, ethoxy groups, isopropoxy groups, t-butoxy groups, n-octyloxy groups, and 2-methoxyethoxy groups.

The aryloxy groups preferably denote substituted or unsubstituted aryloxy groups having 6 to 30 carbon atoms, such as phenoxy groups, 2-methylphenoxy groups, 4-t-butylphenoxy groups, 3-nitrophenoxy groups, and 2-tetradecanoylaminophenoxy groups.

The silyloxy groups preferably denote silyloxy groups having 3 to 20 carbon atoms, such as trimethylsilyloxy groups and t-butyldimethylsilyloxy groups.

The heterocyclic oxy groups preferably denote substituted or unsubstituted heterocyclic oxy groups having 2 to 30 carbon atoms, such as 1-phenyltetrazole-5-oxy groups and 2-tetrahydropyranyloxy groups.

The acyloxy groups preferably denote formyloxy groups, substituted or unsubstituted alkylcarbonyloxy groups having 2 to 30 carbon atoms, and substituted or unsubstituted arylcarbonyloxy groups having 6 to 30 carbon atoms, such as formyloxy groups, acetyloxy groups, pivaloyloxy groups, stearoyloxy groups, benzoyloxy groups, and p-methoxyphenylcarbonyloxy groups.

The carbamoyloxy groups preferably denote substituted or unsubstituted carbamoyloxy groups having 1 to 30 carbon atoms, such as N,N-dimethylcarbamoyloxy groups, N,N-diethylcarbamoyloxy groups, morpholinocarbonyloxy groups, N,N-di-n-octylaminocarbonyloxy groups, and N-n-octylcarbamoyloxy groups.

The alkoxycarbonyloxy groups preferably denote substituted or unsubstituted alkoxycarbonyloxy groups having 2 to 30 carbon atoms, such as methoxycarbonyloxy groups, ethoxycarbonyloxy groups, t-butoxycarbonyloxy groups, and n-octylcarbonyloxy groups.

The aryloxycarbonyloxy groups preferably denote substituted or unsubstituted aryloxycarbonyloxy groups having 7 to 30 carbon atoms, such as phenoxycarbonyloxy groups, p-methoxyphenoxycarbonyloxy groups, and p-n-hexadecyloxyphenoxycarbonyloxy groups.

The amino groups preferably denote amino groups, substituted or unsubstituted alkylamino groups having 1 to 30 carbon atoms, and substituted or unsubstituted anilino groups having 6 to 30 carbon atoms, such as methylamino groups, dimethylamino groups, anilino groups, N-methylanilino groups, and diphenylamino groups.

The acylamino groups preferably denote formylamino groups, substituted or unsubstituted alkylcarbonylamino groups having 1 to 30 carbon atoms, and substituted or unsubstituted arylcarbonylamino groups having 6 to 30 carbon atoms, such as formylamino groups, acetylamino groups, pivaloylamino groups, lauroylamino groups, benzoylamino groups, and 3,4,5-tri-n-octyloxyphenylcarbonylamino groups.

The aminocarbonylamino groups preferably denote substituted or unsubstituted aminocarbonylamino groups having 1 to 30 carbon atoms, such as carbamoylamino groups, N,N-dimethylaminocarbonylamino groups, N,N-diethylaminocarbonylamino groups, and morpholinocarbonylamino groups.

The alkoxycarbonylamino groups preferably denote substituted or unsubstituted alkoxycarbonylamino groups having 2 to 30 carbon atoms, such as methoxycarbonylamino groups, ethoxycarbonylamino groups, t-butoxycarbonylamino groups, n-octadecyloxycarbonylamino groups, and N-methylmethoxycarbonylamino groups.

The aryloxycarbonylamino groups preferably denote substituted or unsubstituted aryloxycarbonylamino groups having 7 to 30 carbon atoms, such as phenoxycarbonylamino groups, p-chlorophenoxycarbonylamino groups, and m-(n-octyloxy)phenoxycarbonylamino groups.

The sulfamoylamino groups preferably denote substituted or unsubstituted sulfamoylamino groups having 0 to 30 carbon atoms, such as sulfamoylamino groups, N,N-dimethylaminosulfonylamino groups, and N-n-octylaminosulfonylamino groups.

The alkyl and arylsulfonylamino groups preferably denote substituted or unsubstituted alkylsulfonylamino groups having 1 to 30 carbon atoms and substituted or unsubstituted arylsulfonylamino groups having 6 to 30 carbon atoms, such as methylsulfonylamino groups, butylsulfonylamino groups, phenylsulfonylamino groups, 2,3,5-trichlorophenylsulfonylamino groups, and p-methylphenylsulfonylamino groups.

The alkylthio groups preferably denote substituted or unsubstituted alkylthio groups having 1 to 30 carbon atoms, such as methylthio groups, ethylthio groups, and n-hexadecylthio groups.

The arylthio groups preferably denote substituted or unsubstituted arylthio groups having 6 to 30 carbon atoms, such as phenylthio groups, p-chlorophenylthio groups, and m-methoxyphenylthio groups.

The heterocyclic thio groups preferably denote substituted or unsubstituted heterocyclic thio groups having 2 to 30 carbon atoms, such as 2-benzothiazolylthio groups and 1-phenyltetrazole-5-ylthio groups.

The sulfamoyl groups preferably denote substituted or unsubstituted sulfamoyl groups having 0 to 30 carbon atoms, such as N-ethylsulfamoyl groups, N-(3-dodecyloxypropyl)sulfamoyl groups, N,N-dimethylsulfamoyl groups, N-acetylsulfamoyl groups, N-benzoylsulfamoyl groups, and N-(N′-phenylcarbamoyl)sulfamoyl groups.

The alkyl and arylsulfinyl groups preferably denote substituted or unsubstituted alkylsulfinyl groups having 1 to 30 carbon atoms and substituted or unsubstituted arylsulfinyl groups having 6 to 30 carbon atoms, such as methylsulfinyl groups, ethylsulfinyl groups, phenylsulfinyl groups, and p-methylphenylsulfinyl groups.

The alkyl and arylsulfonyl groups preferably denote substituted or unsubstituted alkylsulfonyl groups having 1 to 30 carbon atoms and substituted or unsubstituted arylsulfonyl groups having 6 to 30 carbon atoms, such as methylsulfonyl groups, ethylsulfonyl groups, phenylsulfonyl groups, and p-methylphenylsulfonyl groups.

The acyl groups preferably denote formyl groups, substituted or unsubstituted alkylcarbonyl groups having 2 to 30 carbon atoms, substituted or unsubstituted arylcarbonyl groups having 7 to 30 carbon atoms, and substituted or unsubstituted heterocyclic carbonyl groups having 4 to 30 carbon atoms in which the carbonyl group is bonded through a carbon atom, such as acetyl groups, pivaloyl groups, 2-chloroacetyl groups, stearoyl groups, benzoyl groups, p-n-octyloxyphenylcarbonyl groups, 2-pyridylcarbonyl groups, and 2-furylcarbonyl groups.

The aryloxycarbonyl groups preferably denote substituted or unsubstituted aryloxycarbonyl groups having 7 to 30 carbon atoms, such as phenoxycarbonyl groups, o-chlorophenoxycarbonyl groups, m-nitrophenoxycarbonyl groups, and p-t-butylphenoxycarbonyl groups.

The alkoxycarbonyl groups preferably denote substituted or unsubstituted alkoxycarbonyl groups having 2 to 30 carbon atoms, such as methoxycarbonyl groups, ethoxycarbonyl groups, t-butoxycarbonyl groups, and n-octadecyloxycarbonyl groups.

The carbamoyl groups preferably denote substituted or unsubstituted carbamoyl groups having 1 to 30 carbon atoms, such as carbamoyl groups, N-methylcarbamoyl groups, N,N-dimethylcarbamoyl groups, N,N-di-n-octylcarbamoyl groups, and N-(methylsulfonyl)carbamoyl groups.

The aryl and heterocyclic azo groups preferably denote substituted or unsubstituted arylazo groups having 6 to 30 carbon atoms and substituted or unsubstituted heterocyclic azo groups having 3 to 30 carbon atoms, such as phenylazo groups, p-chlorophenylazo groups, 5-ethylthio-1,3,4-thiaziazole-2-ylazo groups.

The imido groups preferably denote N-succinimide groups and N-phthalimide groups.

The phosphino groups preferably denote substituted or unsubstituted phosphino groups having 2 to 30 carbon atoms, such as dimethylphosphino groups, diphenylphosphino groups, and methylphenoxyphosphino groups.

The phosphinyl groups preferably denote substituted or unsubstituted phosphinyl groups having 2 to 30 carbon atoms, such as phosphinyl groups, dioctyloxyphosphinyl groups, and diethoxyphosphinyl groups.

The phosphinyloxy groups preferably denote substituted or unsubstituted phosphinyloxy groups having 2 to 30 carbon atoms, such as diphenoxyphosphinyloxy groups and dioctyloxyphosphinyloxy groups.

The phosphinylamino groups preferably denote substituted or unsubstituted phosphinylamino groups having 2 to 30 carbon atoms, such as dimethoxyphosphinylamino groups and dimethylaminophosphinylamino groups.

The silyl groups preferably denote substituted or unsubstituted silyl groups having 3 to 30 carbon atoms, such as trimethylsilyl groups, t-butyldimethylsilyl groups, and phenyldimethylsilyl groups.

The boron groups preferably denote boric acid, pinacol borane, or catechol borane.

In those of the above-listed functional groups having hydrogen atoms, the hydrogen atom comprised therein can be substituted by the above group. Examples of such functional groups are: alkylcarbonylaminosulfonyl groups, arylcarbonylaminosulfonyl groups, alkylsulfonylaminocarbonyl groups, and arylsulfonylaminocarbonyl groups. More specific examples are: methylsulfonylaminocarbonyl groups, p-methylphenylsulfonylaminocarbonyl groups, acetylaminosulfonyl groups, and benzoylaminosulfonyl groups.

In general formulas (VI) and (XI), m+n1 and m′+n1′ each independently denote an integer ranging from 1 to 6. m and m′ each independently denote an integer ranging from 0 to 5, preferably 0 to 3, and more preferably 0 to 2. When m and m′ denote integers of equal to or greater than 2, plural R⁶s and R^{6′}s may be identical or different from each other. n1 and n1′ each independently denotes an integer ranging from 1 to 6, preferably 1 to 3, and more preferably 1 or 2. When n1 and n1′ denote integers of equal to or greater than 2, plural substituents denoted by general formulas (I) and (VII) may be identical or different from each other.

The gas that is produced by thermal decomposition of the above-described substituent varies with the substituent. For example, when the substituent is a carbamate group, the subsequent thermal decomposition will produce carbon dioxide and C₂R₄ gas (see Y. Brusco, R. M. Dominguez, A. Rotinov, A. Herize, M. Cordova, G. Chuchani, J. Phys. Org. Chem. 2002, 15, 796-800; A. Herize, R. M. Dominguez, A. Rotinov, O. Nunez, G. Chuchani, J. Phys. Org. Chem., 1999, 12, 201-206; and Japanese Unexamined Patent Publication (KOKAI) Heisei No. 7-188234, which are expressly incorporated herein by reference in their entirety).

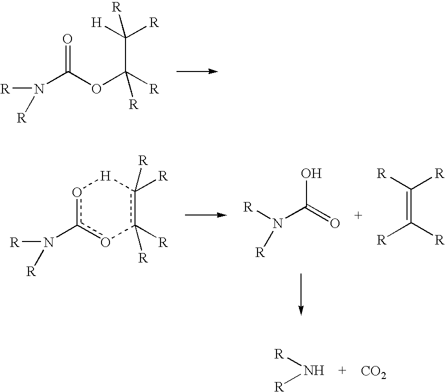

[In the above, R denotes a hydrogen atom or a substituent.]

The compound comprising the above-described substituent can afford good suitability to manufacturing due to high solubility. Further, to enhance sensitivity, it is further desirable to employ a compound with a good thermal decomposition property as the above compound. The thermal decomposition temperature can be employed as an indicator of the thermal decomposition property. In the present invention, the use of a compound with a thermal decomposition temperature of, for example, 150 to 250° C. is preferable, with 160 to 240° C. being further preferable and 170 to 230° C. being of even greater preference. In the present invention, the thermal decomposition temperature refers to a value that is obtained by TG/DTA measurement. As a specific example, an EXSTAR 6000 made by Seiko Instruments, Inc. may be employed to raise the temperature at a rate of 10° C./min over a range of 30 to 550° C. under an N₂ gas flow (at a flow rate of 200 mL/min), and the temperature at the point in time where the rate of weight reduction reaches 10 percent may be adopted as the thermal decomposition temperature.

Specific examples of the compound comprising a substituent having a property of producing a gas by thermal decomposition are given below. However, the present invention is not limited to these specific examples.

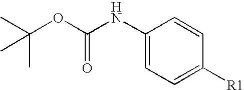

| No. | R1 |
|---|---|
| A-1 | CO₂Me |
| A-2 | CO₂H |
| A-3 | Br |
| A-4 | NH₂ |
| A-5 | H |
| A-6 | CH₂CO₂H |
| A-7 | OH |
| A-8 | Cl |
| A-9 | I |
| A-10 | B(OH)₂ |

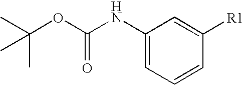

| No. | R1 |
|---|---|
| A-11 | CO₂Me |
| A-12 | CO₂H |
| A-13 | Br |
| A-14 | OH |
| A-15 | B(OH)₂ |

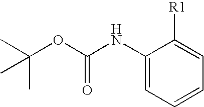

| No. | R1 |
|---|---|
| A-16 | CO₂Me |
| A-17 | CO₂H |
| A-18 | Br |
| A-19 | OH |

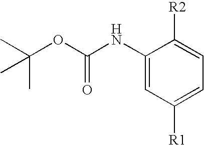

| No. | R1 | R2 |
|---|---|---|
| A-20 | CO₂H | Cl |
| A-21 | CH₃ | CH₃ |
| A-22 | C₄H₉ | CH₃ |
| A-23 | C₄H₉ | C₂H₅ |

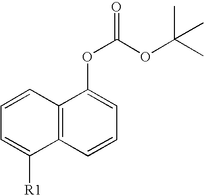

| No. | R1 |
|---|---|
| A-24 | H |
| A-25 | NH₂ |

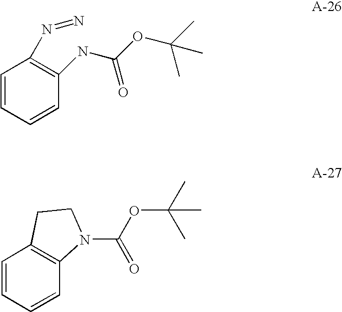

| | |
|---|---|
| | A-28 |
| 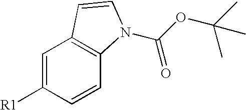 | |

| No. | R1 |
|---|---|
| A-29 | H |
| A-30 | Br |
| A-31 | Cl |
| A-32 | Me |

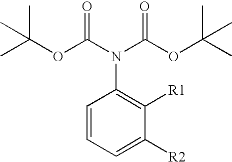

| No. | R1 | R1 |
|---|---|---|
| A-33 | CN | CN |
| A-34 | I | H |

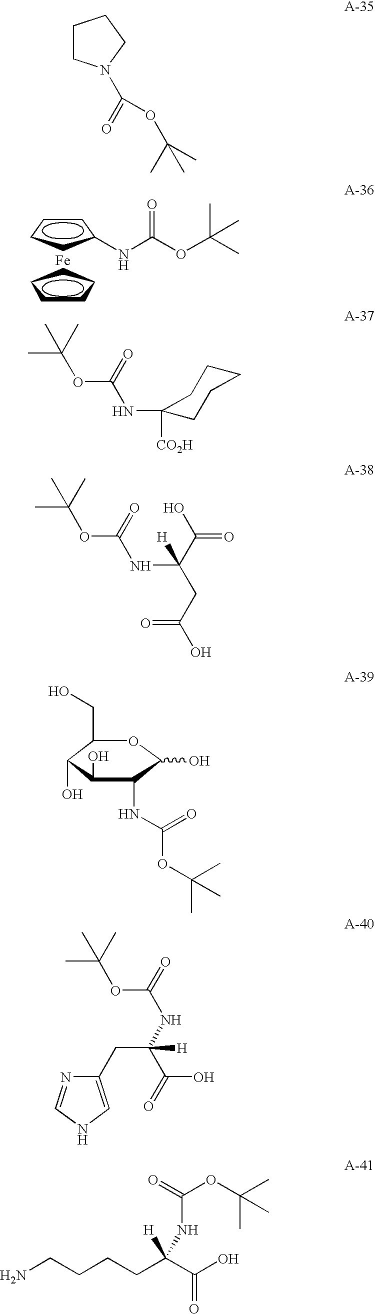

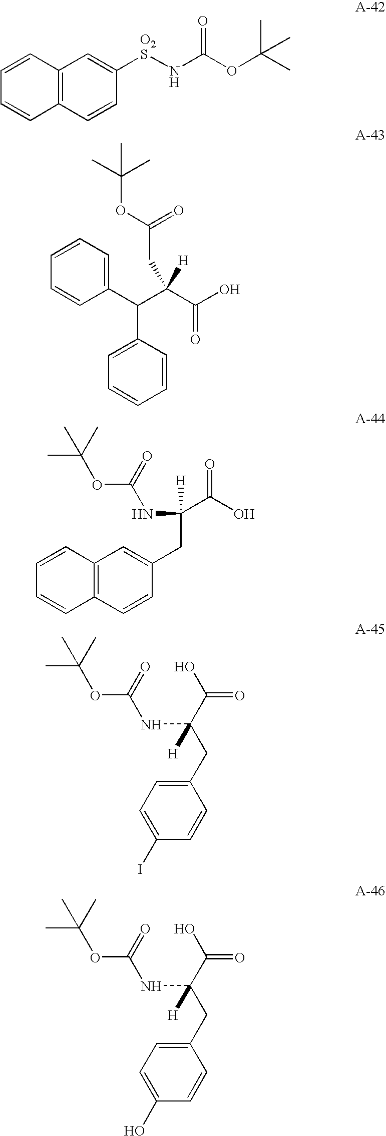

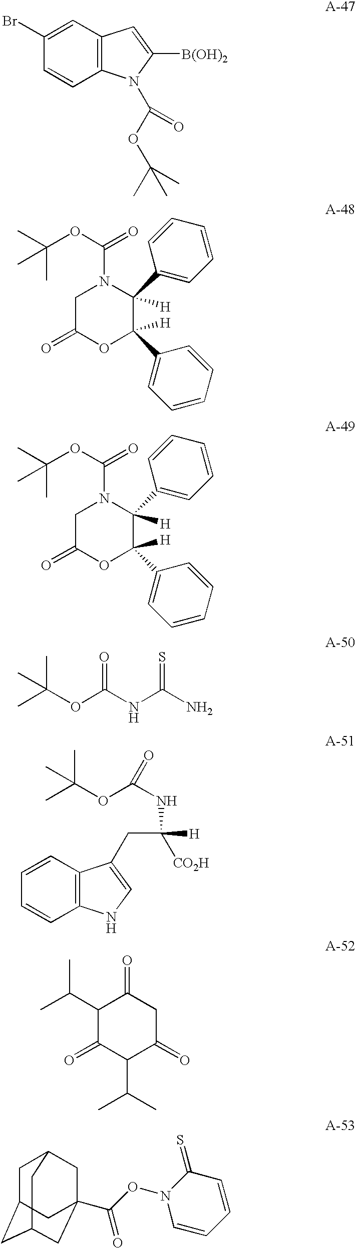

The thermal decomposition temperature of Example Compounds A-1, A-2, A-10, A-12, A-17, A-20, A-25, A-36 to A-43, A-45, A-48, and A-49 was measured by the following method. The results are given in Table 1.

Measurement of Thermal Decomposition Temperature

An EXSTAR 6000 made by Seiko Instruments, Inc. was employed to raise the temperature at a rate of 10° C./min over a range of 30 to 550° C. under an N₂ gas flow (flow rate 200 mL/min), and the thermal decomposition temperature was obtained as the temperature at the point where the weight reduction rate reached 10 percent.

TABLE 1

| | | Decomposition |
|---|---|---|
| | | temperature(° C.) |
| | | (10% |
| Example | | decomposition |
| Compound | Chemical formula | point) |
| A-1 | 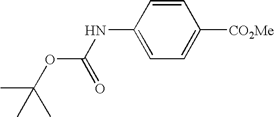 | 187 |
| A-2 | 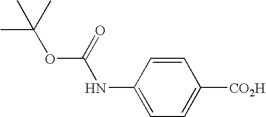 | 200 |
| A-10 | 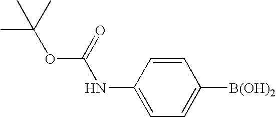 | 202 |
| A-12 | 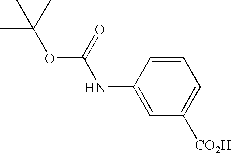 | 195 |
| A-17 | 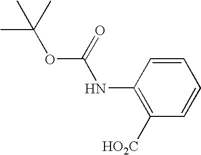 | 155 |
| A-20 | 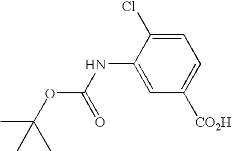 | 216 |
| A-25 | 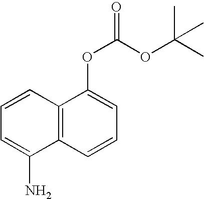 | 159 |
| A-36 | 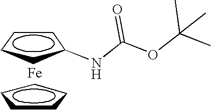 | 179 |
| A-37 | 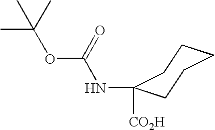 | 177 |
| A-38 | 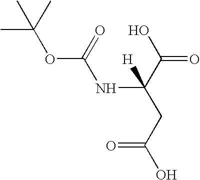 | 175 |
| A-39 | 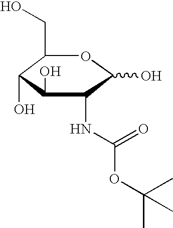 | .194 |
| A-40 | 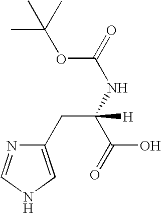 | 195 |
| A-41 | 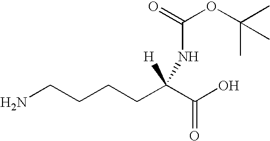 | 205 |
| A-42 | 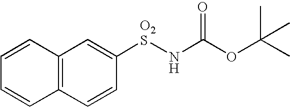 | 166 |
| A-43 | 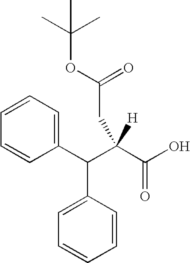 | 160 |
| A-45 | 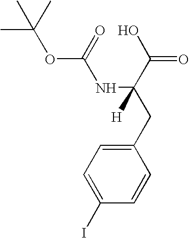 | 150 |
| A-48 | 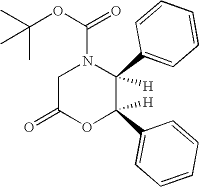 | 206 |
| A-49 | 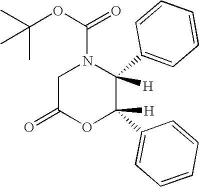 | 206 |

The compound comprising a substituent having a property of producing a gas by thermal decomposition set forth above can be synthesized by known methods, or some of them are available as commercial products.

The above compound may be employed singly or in combination of two or more in the recording layer. The quantity of the compound employed in the recording layer normally falls within a range of 0.1 to 50 weight percent, preferably falls within a range of 0.5 to 45 weight percent, more preferably falls within a range of 3 to 40 weight percent, and further preferably, falls within a range of 5 to 25 weight percent of the dye employed in the recording layer.

Various antifading agents may be incorporated into the recording layer to enhance the resistance to light of the recording layer. Examples of antifading agents are organic oxides and singlet oxygen quenchers. The compounds described in Japanese Unexamined Patent Publication (KOKAI) Heisei No. 10-151861, which is expressly incorporated herein by reference in its entirety, are desirable organic oxides for use as antifading agents. Singlet oxygen quenchers that are described in known publications such as patent specifications may be employed. Specific examples are described in Japanese Unexamined Patent Publication (KOKAI) Showa Nos. 58-175693, 59-81194, 60-18387, 60-19586, 60-19587, 60-35054, 60-36190, 60-36191, 60-44554, 60-44555, 60-44389, 60-44390, 60-54892, 60-47069, and 63-209995; Japanese Unexamined Patent Publication (KOKAI) Heisei No. 4-25492; Japanese Examined Patent Publication (KOKOKU) Heisei Nos. 1-38680 and 6-26028; German Patent No. 350399; and the Journal of the Japanese Chemical Society, October Issue, 1992, p. 1141, which are expressly incorporated herein by reference in their entirety. The compound denoted by general formula (A) below is an example of a desirable singlet oxygen quencher.

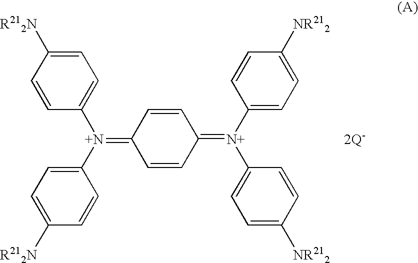

In general formula (A), R²¹ denotes an optionally substituted alkyl group and Q⁻ denotes an anion.

In general formula (A), R²¹ preferably denotes an optionally substituted alkyl group having 1 to 8 carbon atoms, more preferably an unsubstituted alkyl group having 1 to 6 carbon atoms. Examples of substituents on the alkyl group are: halogen atoms (such as F and Cl), alkoxy groups (such as methoxy groups and ethoxy groups), alkylthio groups (such as methylthio groups and ethylthio groups), acyl groups (such as acetyl groups and propionyl groups), acyloxy groups (such as acetoxy groups and propionyloxy groups), hydroxy groups, alkoxycarbonyl groups (such as methoxycarbonyl groups and ethoxycarbonyl groups), alkenyl groups (such as vinyl groups), and aryl groups (such as phenyl groups and naphthyl groups). Of these, halogen atoms, alkoxy groups, alkylthio groups, and alkoxycarbonyl groups are preferable. Preferable examples of the anion denoted by Q⁻ are: ClO₄⁻, AsF₆⁻, BF₄⁻, and SbF₆⁻.

Examples of the compound denoted by general formula (A) (Compound Nos. A-1 to A-8) are given in Table 2.

TABLE 2

| Compound No. | R²¹ | Q⁻ |
|---|---|---|
| A-1 | CH₃ | ClO⁴⁻ |
| A-2 | C₂H₅ | ClO⁴⁻ |
| A-3 | n-C₃H₇ | ClO⁴⁻ |
| A-4 | n-C₄H₉ | ClO⁴⁻ |
| A-5 | n-C₅H₁₁ | ClO⁴⁻ |
| A-6 | n-C₄H₉ | SbF⁶⁻ |
| A-7 | n-C₄H₉ | BF⁴⁻ |
| A-8 | n-C₄H₉ | AsF⁶⁻ |

The quantity of the above-described antifading agent, such as a singlet oxygen quencher, normally falls within a range of 0.1 to 50 weight percent, preferably a range of 0.5 to 45 weight percent, more preferably a range of 3 to 40 weight percent, and further preferably, a range of 5 to 25 weight percent of the quantity of dye.

Information can be recorded on the recording layer comprising the dye for recording and the compound comprising a substituent having a property of producing a gas by thermal decomposition by irradiating a laser beam onto the optical information recording medium of the present invention. The recording of information on the optical information recording medium is conducted by changing the optical characteristics of portions of the recording layer irradiated by the laser beam. The change in optical characteristics is thought to be the result of physical or chemical changes (such as the generation of pits) produced by increasing the temperature locally in portions of the recording layer by causing such portions to absorb light by irradiation of a laser beam. Information that has been recorded in the recording layer can be read (reproduced), for example, by scanning with a laser beam of the same wavelength as the laser beam employed in recording and detecting the difference in an optical characteristic such as reflectance between portions in which the optical characteristics of the recording layer have been changed (recorded portions) and portions in which they have not been changed (unrecorded portions). In the present invention, information is preferably recorded by thermally decomposing the substituent present in the above-described compound by irradiation of a laser beam, thereby forming voids in pits by means of the gas thus generated. More preferably, the dye for recording generates heat by absorbing the laser beam, and the heat thus generated decomposes the above-described substituent, producing a gas. The above-described compound can function as a void-forming agent in the recording layer in this manner, resulting in a large difference in refractive index between portions in which voids have been formed by irradiation by the laser beam and portions that have not been irradiated by the laser beam, enhancing recording characteristics.

The optical information recording medium of the present invention comprises at least a recording layer comprising the dye for recording and the above-described compound on a support. In addition to the recording layer, it may comprise a reflective layer, a protective layer, and the like.

Any of various materials employed as support materials in conventional optical information recording media may be employed as the support in the present invention.

Specific examples are: glass, acrylic resins such as polycarbonate and polymethyl methacrylate, vinyl chloride resins such as polyvinyl chloride and vinyl chloride copolymers, epoxy resins, amorphous polyolefin, polyester, and metals such as aluminum. These materials may be employed in combination as desired.

Among these materials, from the perspective of resistance to humidity, dimensional stability, and low cost, the use of amorphous polyolefin, polycarbonate, and other thermoplastic resins is preferable, and the use of polycarbonate is further preferable. When employing these resins, the support can be manufactured by injection molding.

The support thickness generally falls within a range of 0.7 to 2 mm, preferably a range of 0.9 to 1.6 mm, and more preferably, 1.0 to 1.3 mm.

An undercoating layer can be formed to enhance flatness and increase adhesion on the support surface on the side on which the light reflective layer, described further below, is positioned.

Tracking guide grooves or irregularities denoting information such as address signals (pregrooves) are normally formed on the surface of the support on which the recording layer is formed. In the optical information recording medium of the present invention, it is preferable to employ a support on which these are formed at a track pitch that is narrower than that of a CD-R or DVD-R so as to permit high-density recording. Details relating to the desirable range of the track pitch are given below.

Embodiments (1) and (2) below are examples of preferable embodiments of the optical information recording medium of the present invention.

Embodiment (1): An optical information recording medium comprising a dye-containing recordable recording layer and a cover layer 0.01 to 0.5 mm in thickness in this order on a support 0.7 to 2 mm in thickness.

Embodiment (2): An optical information recording medium comprising a dye-containing recordable recording layer and a protective support 0.1 to 1.0 mm in thickness in this order on a support 0.1 to 1.0 mm in thickness.

In embodiment (1), it is preferable for the track pitch of the pregrooves formed on the support to be 50 to 500 nm, the groove width to be 25 to 250 nm, and the groove depth to be 5 to 150 nm. In embodiment (2), it is preferable for the track pitch of the pregrooves formed on the substrate to be 200 to 600 nm, the groove width to be 50 to 300 nm, the groove depth to be 30 to 150 nm, and the wobble amplitude to be 5 to 50 nm.

### Optical Information Recording Medium of Embodiment (1)

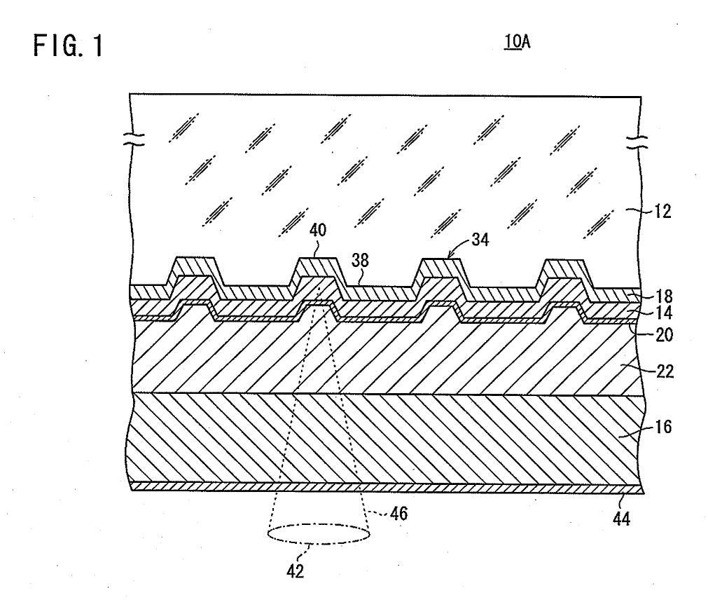

The optical information recording medium of embodiment (1) comprises at least a support, a recordable recording layer, and a cover layer. FIG. 1 shows a specific example of the optical information recording medium of embodiment (1). First optical information recording medium 10A shown in FIG. 1 is sequentially comprised of first light reflective layer 18, first recordable recording layer 14, barrier layer 20, first bonding or adhesive layer 22, and cover layer 16 on first support 12.

The materials constituting these components will be sequentially described below.

### Support

Pregrooves (guide grooves) having a shape such that the track pitch, groove width (half width), groove depth, and wobble amplitude are all within the ranges set forth below are formed on the support of embodiment (1). The pregrooves are provided to achieve a higher recording density than in a CD-R or DVD-R. For example, they are suited to when the optical information recording medium of the present invention is employed with a blue-violet laser.

The track pitch of the pregrooves falls within a range of 50 to 500 nm, the upper limit preferably being equal to or less than 420 nm, more preferably equal to or less than 370 nm, and still more preferably, equal to or less than 330 nm. The lower limit is preferably equal to or greater than 100 nm, more preferably equal to or greater than 200 nm, and still more preferably, equal to or greater than 260 nm. When the track pitch is equal to or greater than 50 nm, not only is it possible to correctly form the pregrooves, but the generation of crosstalk can be avoided. At equal to or less than 500 nm, high-density recording is possible.

The groove width (half width) of the pregrooves falls within a range of 25 to 250 nm, the upper limit preferably being equal to or less than 240 nm, more preferably equal to or less than 230 nm, and still more preferably, equal to or less than 220 nm. The upper limit is preferably equal to or greater than 50 nm, more preferably equal to or greater than 80 nm, and still more preferably, equal to or greater than 100 nm. When the pregroove width is equal to or greater than 25 nm, the grooves can be adequately transferred during forming and an increase in the error rate during recording can be inhibited. At equal to or less than 250 nm, the grooves can still be adequately transferred during forming, while the generation of crosstalk due to the widening of the pits formed during recording can be avoided.

The groove depth of the pregrooves falls within a range of 5 to 150 nm, the upper limit preferably being equal to or less than 85 nm, more preferably equal to or less than 80 nm, and still more preferably, equal to or less than 75 nm. The lower limit is preferably equal to or greater than 10 nm, more preferably equal to or greater than 20 nm, and still more preferably, equal to or greater than 28 nm. When the groove depth of the pregrooves is equal to or greater than 5 nm, an adequate degree of modulation can be achieved in recording, and at equal to or less than 150 nm, high reflectance can be achieved.

The upper limit of the groove tilt angle of the pregrooves is preferably equal to or less than 80°, more preferably equal to or less than 75°, further preferably equal to or less than 70°, and still more preferably, equal to or less than 65°. The lower limit is preferably equal to or greater than 20°, more preferably equal to or greater than 30°, and still more preferably, equal to or greater than 40°.

When the groove tilt angle of the pregrooves is equal to or greater than 20°, an adequate tracking error signal amplitude can be achieved, and at equal to or less than 80°, shaping properties are good.

### Recordable Recording Layer

The recordable recording layer of embodiment (1) can be formed as follows. A dye is dissolved in a suitable solvent with or without a binder or the like to prepare a coating liquid. Next, the coating liquid is coated on the support, or over a light reflective layer, described further below, to form a coating. The coating is then dried to form the recordable recording layer of embodiment (1). The recordable recording layer may be a single layer or multiple layers. When a multilayered structure is employed, the step of applying the coating liquid is conducted multiple times.

The concentration of the dye in the coating liquid normally falls within a range of 0.01 to 15 weight percent, preferably falls within a range of 0.1 to 10 weight percent, more preferably falls within a range of 0.5 to 5 weight percent, and still more preferably, falls within a range of 0.5 to 3 weight percent.

Examples of the solvent employed in preparing the coating liquid are: esters such as butyl acetate, ethyl lactate, and Cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as tetrahydrofuran, ethyl ether, and dioxane; alcohols such as ethanol, n-propanol, isopropanol, and n-butanol diacetone alcohol; fluorine solvents such as 2,2,3,3-tetrafluoro-1-propanol; and glycol ethers such as ethylene glycol monomethylether, ethylene glycol monoethylether, and propylene glycol monomethylether.

The solvents may be employed singly or in combinations of two or more in consideration of the solubility of the dyes employed. Binders, oxidation inhibitors, UV absorbing agents, plasticizers, lubricants, and various other additives may be added to the coating liquid as needed.

Examples of coating methods are spraying, spincoating, dipping, roll coating, blade coating, doctor roll coating, and screen printing.

During coating, the temperature of the coating liquid preferably falls within a range of 23 to 50° C., more preferably within a range of 24 to 40° C., and further preferably, within a range of 23 to 38° C.

The thickness of the recordable recording layer is preferably equal to or less than 300 nm on lands (protrusions on the support), more preferably equal to or less than 250 nm, further preferably equal to or less than 200 nm, and still more preferably, equal to or less than 180 nm. The lower limit is preferably equal to or greater than 1 nm, more preferably equal to or greater than 3 nm, and still more preferably, equal to or greater than 5 nm.

The thickness of the recordable recording layer is preferably equal to or less than 400 nm on grooves (indentations in the support), more preferably equal to or less than 300 nm, and still more preferably, equal to or less than 250 nm. The lower limit is preferably equal to or greater than 10 nm, more preferably equal to or greater than 15 nm, and still more preferably, equal to or greater than 20 nm.

The ratio of the thickness of the recordable recording layer on lands to the thickness of the recordable recording layer on grooves (thickness on lands/thickness on grooves) is preferably equal to or greater than 0.1, more preferably equal to or greater than 0.13, further preferably equal to or greater than 0.15, and still more preferably, equal to or greater than 0.17. The upper limit is preferably equal to or less than 1, more preferably equal to or less than 0.9, further preferably equal to or less than 0.85, and still more preferably, equal to or less than 0.8.

To further enhance the resistance to light of the recordable recording layer, various antifading agents can be incorporated into the recordable recording layer. Singlet oxygen quenchers are normally employed as antifading agents. The singlet oxygen quenchers are as set forth above.

### Cover Layer

The cover layer in embodiment (1) is normally adhered through a bonding agent or adhesive onto the above-described recordable recording layer or onto a barrier layer such as that shown in FIG. 1.

The cover layer is not specifically limited, other than that it be a film of transparent material. An acrylic resin such as a polycarbonate or polymethyl methacrylate; a vinyl chloride resin such as polyvinyl chloride or a vinyl chloride copolymer; an epoxy resin; amorphous polyolefin; polyester; or cellulose triacetate is preferably employed. Of these, the use of polycarbonate or cellulose triacetate is more preferable.

The term “transparent” means having a transmittance of equal to or greater than 80 percent for the beam used in recording and reproducing.

The cover layer may further contain various additives so long as they do not compromise the effect of the present invention. For example, UV-absorbing agents may be incorporated to cut light with the wavelength of equal to or shorter than 400 nm and/or dyes may be incorporated to cut light with the wavelength of equal to or longer than 500 nm.

As for the physical surface properties of the cover layer, both the two-dimensional roughness parameter and three-dimensional roughness parameter are preferably equal to or less than 5 nm.

From the perspective of the degree of convergence of the beam employed in recording and reproducing, the birefringence of the cover layer is preferably equal to or lower 10 nm.

The thickness of the cover layer can be suitably determined based on the NA or wavelength of the laser beam irradiated in recording and reproducing. In the present invention, the thickness preferably falls within a range of 0.01 to 0.5 mm, more preferably a range of 0.05 to 0.12 mm.

The total thickness of the cover layer and bonding or adhesive layer is preferably 0.09 to 0.11 mm, more preferably 0.095 to 0.105 mm.

A protective layer (hard coating layer 44 in the embodiment shown in FIG. 1) may be provided on the incident light surface of the cover layer during manufacturing of the optical information recording medium to prevent scratching of the incident light surface.

An adhesive layer can be provided between the cover layer and the recordable recording layer or barrier layer for adhesion.

Examples of the adhesive employed in the adhesive layer are acrylic, rubber, and silicone adhesives. From the perspectives of transparency and durability, acrylic adhesives are preferable. Preferable acrylic adhesive is an acrylic adhesive comprising a main component in the form of 2-ethylhexyl acrylate, n-butyl acrylate, or the like copolymerized with a short-chain alkyl acrylate or methacrylate, such as methyl acrylate, ethyl acrylate, or methyl methacrylate to increase the cohesive force, and the component capable of becoming a crosslinking point with a crosslinking agent, such as acrylic acid, methacrylic acid, an acrylamide derivative, maleic acid, hydroxylethyl acrylate, or glycidyl acrylate. The type and blending ratio of the main component, short-chain component, and component for the addition of a crosslinking point can be suitably adjusted to vary the glass transition temperature (Tg) and crosslinking density.

Isocyanates are examples of crosslinking agents that can be combined with the adhesive. Examples of isocyanate crosslinking agents that are suitable for use are: isocyanates such as tolylene diisocyanate, 4,4′-diphenylemthane diisocyanate, hexamethylene diisocyanate, xylylene diisocyanate, naphthylene-1,5-diisocyanate, o-toluidine isocyanate, isophorone diisocyanate, and triphenylmethane triisocyanate; products of these isocyanates and polyalcohols; and polyisocyanates produced by condensation of isocyanates. These isocyanates are commercially available under the trade names Coronate L, Coronate H L, Coronate 2030, Coronate 2031, Millionate M R, and Millionate HTL made by Nippon Polyurethane Industry Co., Ltd.; Takenate D-102, Takenate D-110N, Takenate D-200, and Takenate D-202 made by Takeda Pharmaceutical Co., Ltd.; Desmodur L, Desmodur I L, Desmodur N, and Desmodur H L made by Sumitomo Bayer Urethane Co., Ltd.

The method of forming the adhesive layer is not specifically limited. It is possible to uniformly coat a prescribed quantity of adhesive to the surface of the barrier layer or recordable recording layer (the surface being adhered), place the cover layer thereover, and cure the adhesive. It is also possible to uniformly coat a prescribed quantity of the adhesive to one surface of the cover layer to form an adhesive coating in advance, adhere the coating to the surface being adhered, and cure the adhesive coating.

It is also possible to employ a commercial adhesive film on which an adhesive layer has been provided in advance as a cover layer.

The thickness of the adhesive layer preferably falls within a range of 0.1 to 100 micrometers, more preferably within a range of 0.5 to 50 micrometers, and further preferably, within a range of 10 to 30 micrometers.

The cover layer may be formed by spin coating UV-curing resin.

When forming voids in the recording layer by irradiation of a laser beam as set forth above, since the formation of voids by irradiation of a laser beam is normally accompanied by distortion of the recording layer, and since impeding this distortion of the recording layer precludes good void formation, there is a risk of diminished recording characteristics. In an optical information recording medium comprising on a support a light reflective layer, a recording layer, a barrier layer, an adhesive layer, and a cover layer in this order, the support and the light reflective layer normally have greater rigidity than the adhesive layer and barrier layer. Thus, the recording layer pushes up the barrier layer during the formation of voids. When the layers positioned between the barrier layer and the cover layer are suitably flexible, a concave distortion can be produced in these layers. When the layers positioned between the barrier layer and cover layer can deform readily, it is possible to form good pits without impeding formation of voids in the recording layer. For good void formation, it is preferable for the adhesive layer to be suitably flexible.

### Other Layers

The optical information recording medium of embodiment (1) may optionally comprise other layers in addition to the above-described essential layers so long as the effect of the present invention is not compromised. Examples of such optional layers are a label layer having a desired image that is formed on the back of the support (the reverse unformed side from the side on which the recordable recording layer is formed), a light reflective layer positioned between the support and the recordable recording layer (described in detail further below), a barrier layer positioned between the recordable recording layer and the cover layer (described in detail further below), and a boundary layer positioned between the above light reflective layer and the recordable recording layer. The “label layer” may be formed from UV-curing resin, thermosetting resin, or heat-drying resin.

Each of the above-described essential layers and optional layers may have a single-layer or multilayer structure.

To increase reflectance for the laser beam and impart functions that enhance recording and reproducing characteristics to the optical information recording medium of embodiment (1), a light reflective layer is preferably formed between the support and the recordable recording layer.

The light reflective layer can be formed on the support by vacuum vapor deposition, sputtering, or ion plating of a light reflective substance with high reflectance for the laser beam.

The thickness of the light reflective layer generally falls within a range of 10 to 300 nm, preferably a range of 20 to 200 nm.

The above reflectance is preferably equal to or greater than 70 percent.

Examples of light reflective substances of high reflectance are: metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi; and stainless steel. These light reflective substances may be employed singly, in combinations of two or more, or as alloys. Of these, the preferable substances are: Cr, Ni, Pt, Cu, Ag, Au, Al, and stainless steel; the more preferable substances are: Au, Ag, Al, and their alloys; and the substances of greatest preference are: Au, Ag, and their alloys.

### Barrier Layer (Intermediate Layer)

In the optical information recording medium of embodiment (1), as shown in FIG. 1, it is preferable to form a barrier layer between the recordable recording layer and the cover layer.

The barrier layer can be provided to enhance the storage properties of the recordable recording layer, enhance adhesion between the recordable recording layer and cover layer, adjust the reflectance, adjust thermal conductivity, and the like.

The material employed in the barrier layer is a material that passes the beam employed in recording and reproducing; it is not specifically limited beyond being able to perform this function. For example, it is generally desirable to employ a material with low permeability to gas and moisture, a material that does not corrode upon contact with a reflective layer material such as an Ag alloy; and a material that does not corrode in a hot, humid environment. A material that is also a dielectric is preferred.

Specifically, materials in the form of nitrides, oxides, carbides, and sulfides of Zn, Si, Ti, Te, Sn, Mo, Ge, and the like are preferable. MoO₂, GeO₂, TeO, SiO₂, TiO₂, ZUO, SnO₂, ZnO—Ga₂O₃, Nb₂O₅, and Ta₂O₅ are preferable and SnO₂, ZnO—Ga₂O₃, SiO₂, Nb₂O₅, and Ta₂O₅ are more preferable.

The barrier layer can be formed by vacuum film-forming methods such as vacuum vapor deposition, DC sputtering, RF sputtering, and ion plating. Of these, sputtering is preferred.

The thickness of the barrier layer preferably falls within a range of 1 to 200 nm, more preferably within a range of 2 to 100 nm, and further preferably, within a range of 3 to 50 nm.

### Optical Information Recording Medium of Embodiment (2)

The optical information recording medium of embodiment (2) comprises at least a support, a recordable recording layer, and a protective substrate, preferably in adhered form.

### Representative Layer Structures are Given Below:

(1) The first layer structure is a configuration in which a recordable recording layer, light reflective layer, and bonding layer are sequentially formed on a support, with a protective support being provided over the adhesive layer.
(2) The second layer structure is a configuration in which a recordable recording layer, light reflective layer, protective layer, and bonding layer are sequentially formed on a support, with a protective support being provided over the adhesive layer.
(3) The third layer structure is a configuration in which a recordable recording layer, light reflective layer, protective layer, bonding layer, and protective layer are sequentially formed on a support, with a protective support being provided over the protective layer.
(4) The fourth layer structure is a configuration in which a recordable recording layer, light reflective layer, protective layer, bonding layer, protective layer, and light reflective layer are sequentially formed on a support, with a protective support being provided over the light reflective layer.
(5) The fifth layer structure is a configuration in which a recordable recording layer, light reflective layer, bonding layer, and light reflective layer are sequentially formed on a substrate, with a protective support being provided over the reflective layer.

Layer structures (1) through (5) above are merely examples. The layer structure need not follow the order indicated above; some parts can be interchanged each other or can be omitted. The recordable recording layer may also be formed on the protective support side. In that case, an optical information recording medium capable of recording and reproducing from both sides is obtained. Further, each of the layers may be a single layer or comprised of multiple layers.

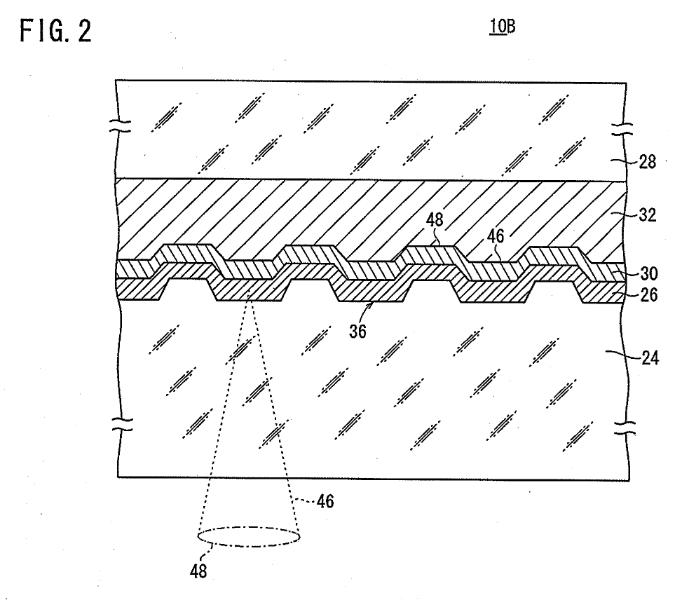

Among the above, the example of a configuration comprising, from the support side, a recordable recording layer, light reflective layer, bonding layer, and protective layer in this order on a support will be described in detail below as the optical information recording medium of embodiment (2). FIG. 2 shows a specific example of an optical information recording medium having the above configuration. As shown in FIG. 2, second optical information recording medium 10B comprises second recordable recording layer 26, second light reflective layer 30, second bonding layer 32, and protective substrate 28 in this order on second support 2.

### Support

Pregrooves (guide grooves) having a shape such that the track pitch, groove width (half width), groove depth, and wobble amplitude are all within the ranges set forth below are formed on the support of embodiment (2). The pregrooves are provided to achieve a higher recording density than in a CD-R or DVD-R. For example, they are suited to when the optical information recording medium of the present invention is employed with a blue-violet laser.

The track pitch of the pregrooves falls within a range of 200 to 600 nm, the upper limit preferably being equal to or less than 450 nm, more preferably equal to or less than 430 nm. The lower limit is preferably equal to or greater than 300 nm, more preferably equal to or greater than 330 nm, and still more preferably, equal to or greater than 370 nm. When the track pitch is equal to or greater than 200 nm, not only is it possible to correctly form the pregrooves, but the generation of crosstalk can be avoided. At equal to or less than 600 nm, high-density recording is possible.

The groove width (half width) of the pregrooves falls within a range of 50 to 300 nm, the upper limit preferably being equal to or less than 290 nm, more preferably equal to or less than 280 nm, and still more preferably, equal to or less than 250 nm. The upper limit is preferably equal to or greater than 100 nm, more preferably equal to or greater than 120 nm, and still more preferably, equal to or greater than 140 nm. When the groove width of the pregrooves is equal to or greater than 50 nm, the grooves can be adequately transferred during forming and an increase in the error rate during recording can be inhibited. At equal to or less than 300 nm, the generation of crosstalk due to the widening of the pits formed during recording can be avoided and a suitable degree of modulation can be achieved.

The groove depth of the pregrooves falls within a range of 30 to 150 nm, the upper limit preferably being equal to or less than 140 nm, more preferably equal to or less than 130 nm, and still more preferably, equal to or less than 120 nm. The lower limit is preferably equal to or greater than 40 nm, more preferably equal to or greater than 50 nm, and still more preferably, equal to or greater than 60 nm. When the groove depth of the pregrooves is equal to or greater than 30 nm, an adequate degree of modulation can be achieved in recording, and when equal to or less than 150 nms, high reflectance can be achieved.

The thickness of the support generally falls within a range of 0.1 to 1.0 mm, preferably a range of 0.2 to 0.8 mm, and more preferably, a range of 0.3 to 0.7 mm.

To improve flatness and increase adhesive strength, an undercoating layer can be formed on the surface of the support on the side on which the recordable recording layer, described further below, is formed.

Examples of materials employed in the undercoating layer are: polymeric substances such as polymethyl methacrylate, acrylic acid and methacrylic acid copolymers, styrene and maleic anhydride copolymers, polyvinylalcohol, N-methylolacrylamide, styrene and vinyltoluene copolymers, chlorosulfonated polyethylene, nitrocellulose, polyvinyl chloride, chlorinated polyolefin, polyester, polyimide, vinyl acetate and vinyl chloride copolymers, ethylene and vinyl acetate copolymers, polyethylene, polypropylene, and polycarbonate; and surface modifying agents such as silane coupling agents.

The undercoating layer can be formed by dissolving or dispersing the above material in a suitable solvent to prepare a coating liquid, and coating the coating liquid to the surface of the support by a coating method such as spin coating, dip coating, or extrusion coating.

The thickness of the undercoating layer normally falls within a range of 0.005 to 20 micrometers, preferably within a range of 0.01 to 10 micrometers.

### Recordable Recording Layer

Details of the recordable recording layer in embodiment (2) are identical to those of the recordable recording layer in embodiment (1).

### Light Reflective Layer

A light reflective layer can be formed on the recordable recording layer in embodiment (2) to increase reflectance for the laser beam and impart functions that improve recording and reproducing characteristics. Details of the light reflective layer in embodiment (2) are identical to those of the light reflective layer in embodiment (1).

### Bonding Layer

A bonding layer can be provided between the light reflective layer and the protective layer in embodiment (2) to increase adhesion between above-described the light reflective layer and the protective support, described further below.

Photosetting resins are preferable as the material included in the bonding layer, with a photosetting resin having a low curing shrinkage rate being more preferable to prevent warping of the disk. Examples of such photosetting resins are UV-curable resins (UV-curable bonding agents) such as SD-640 and SD-661 made by Dainippon Ink and Chemicals, Inc.

The thickness of the bonding layer preferably falls within a range of 1 to 1,000 micrometers to impart elasticity.

### Protective Support

The protective support (dummy support) in embodiment (2) may be of the same material and shape as the above-described support. The thickness of the protective support normally falls within a range of 0.1 to 1.0 mm, preferably falls within a range of 0.2 to 0.8 mm, and more preferably falls within a range of 0.3 to 0.7 mm. When manufacturing a recording medium having multiple recording layers, it is also possible for pregrooves and layers such as recordable recording layers and reflective layers to be provided on the protective support side. This method is sometimes referred to as the inverse stacking method. The recording and reproducing wavelength for the recording layers formed on the protective support side may be identical to or different from that of the recording layer provided on the support that is not a protective support. Specifically, the track pitch, groove shape, and various layer materials such as the recordable recording layer material, reflective layer material, and undercoating layer material may be identical or different among multiple recording layers.

### Protective Layer

Depending on the layer structure of the optical information recording medium of embodiment (2), protective layers may be provided to physically or chemically protect light reflective layers, recordable recording layers, and the like.

Examples of the material employed in the protective layers are: inorganic substances such as ZnS, ZnS—SiO₂, SiO, SiO₂, MgF₂, SnO₂, and Si₃N₄; and organic substances such as thermoplastic resins, thermosetting resins, and UV-curable resins.

The protective layer can be formed, for example, by adhering a film obtained by plastic extrusion processing through an adhesive to the light reflective layer. It may also be provided by a method such as vacuum vapor deposition, sputtering, or coating.

When a thermoplastic resin or thermosetting resin is employed as the protective layer, the protective layer may be formed by dissolving the resin in a suitable solvent to prepare a coating liquid, and then coating and drying the coating liquid. When forming a protective layer with a UV-curable resin, the UV-curable resin may be employed as is or dissolved in a suitable solvent to prepare a coating liquid, which is then coated and cured by irradiation with UV light. Various additives such as antistatic agents, oxidation inhibitors, and UV-absorbing agents may be added to the coating liquid depending on the objective.

The thickness of the protective layer normally falls within a range of 0.1 micrometer to 1 mm.

### Other Layers

In addition to the above-described layers, other optional layers may be present in the optical information recording medium of embodiment (2) to the extent that the effect of the present invention is not compromised. Details of these other optional layers are identical to those of the other optional layers of embodiment (1).

### Method of Recording Information

The present invention further relates to a method of recording information on an optical information recording medium comprising a recording layer on a support. In the method of recording information of the present invention, information is recorded on a recording layer comprising a dye for recording and a compound comprising a substituent having a property of producing a gas by thermal decomposition by irradiation of a laser beam onto the optical information recording medium of the present invention.

By way of example, information is recorded on the above-described preferred optical information recording medium of embodiment (1) or (2) in the following manner.

First, while rotating an optical information recording medium at a certain linear speed (such as 0.5 to 10 m/s) or a certain angular speed, a laser beam for recording, such as a semiconductor laser beam, is directed from the support side or protective layer side. Irradiation by this laser beam changes the optical properties of the portions that are irradiated, thereby recording information. In the embodiment shown in FIG. 1, recording laser beam 46 such as a semiconductor laser beam is directed from cover layer 16 side through first object lens 42 (having a numerical aperture NA of 0.85, for example). Irradiation by laser beam 46 causes recordable recording layer 14 to absorb laser beam 46, resulting in a local rise in temperature. This is thought to produce a physical or chemical change (such as generating pits), thereby altering the optical characteristics and recording information. Similarly, as shown in the embodiment of FIG. 2, recording laser beam 46 such as a semiconductor laser beam is directed through second object lens 48 of a numerical aperture NA of 0.65, for example, from second support 24 side. Irradiation by laser beam 46 causes second recordable recording layer 26 to absorb laser beam 46, resulting in a local rise in temperature. This is thought to produce a physical or chemical change (such as generating pits), thereby altering the optical characteristics and recording information.

In the present invention, information is preferably recorded by irradiation of a laser beam having a wavelength of equal to or shorter than 440 nm. A semiconductor laser beam having an oscillation wavelength falling within a range of equal to or shorter than 440 nm is suitable for use as a recording beam. A blue-violet semiconductor laser beam having an oscillation wavelength falling within a range of 390 to 440 nm (preferably 390 to 415 nm) and a blue-violet SHG laser beam having a core oscillation wavelength of 425 nm obtained by halving the wavelength of an infrared semiconductor laser beam having a core oscillation wavelength of 850 nm with an optical waveguide device are examples of preferable light sources. In particular, a blue-violet semiconductor laser beam having an oscillation wavelength of 390 to 415 nm is preferably employed from the perspective of recording density. The information that is thus recorded can be reproduced by directing the semiconductor laser beam from the support side or protective layer side while rotating the optical information recording medium at the same constant linear speed as above, and detecting the reflected beam.

The remaining details of the method of recording information of the present invention are as set forth above in the description of the optical information recording medium of the present invention.

### Method of Using Compound

The present invention further relates to a method of using a compound comprising a substituent having a property of producing a gas by thermal decomposition as an additive in a solution comprising a dye. The present inventors discovered that the light-toughness of a dye can be enhanced by adding a compound comprising a substituent having a property of producing a gas by thermal decomposition to a dye-containing solution. This is presumed to be the result of the compound suppressing association of the dye in the dye-containing solution. That is, the compound can be employed as a light-toughness enhancing agent for dye-containing solutions. The coating liquid for forming a recording layer of the optical information recording medium is a specific example of a dye-containing solution. Details of such a compound and the method of using it are as set forth above.

### EXAMPLES

The present invention will be described in detail below based on examples. However, the present invention is not limited to the examples.

### Example 1

### Preparation of Optical Information Recording Medium

(Preparation of Support)

An injection-molded substrate comprised of polycarbonate resin, having spiral pregrooves 1.1 mm in thickness, 120 mm in outer diameter and 15 mm in inner diameter (track pitch: 320 nm; in-groove width: 140 nm; groove depth: 40 nm; groove tilt angle: 65°; wobble amplitude: 20 nm) was prepared. Mastering of the stamper employed during injection-molding was conducted by electronic beam cutting.

(Formation of Light Reflective Layer)

Under an argon atmosphere, DC sputtering was used to form a light reflective layer of AgNdCu alloy (Ag: 98.1 at %, Nd: 0.7 at %, and Cu: 0.9 at %) in the form of a vacuum film layer 100 nm in thickness on the support with a cube made by Unaxis Corp. The film thickness was 100 nm. The film thickness on the light reflective layer was adjusted by adjusting the sputtering duration.

(Formation of Recordable Recording Layer)

A 2 g quantity of Dye 1 (the dye described in Example 1 in Japanese Unexamined Patent Publication (KOKAI) No. 2005-228402, which is expressly incorporated herein by reference in its entirety) and 0.2 g of Example Compound A-20 were dissolved in 100 mL of 2,2,3,3-tetrafluoropropanol to prepare a dye-containing coating liquid. The dye-containing coating liquid that had been prepared was coated by spin coating on the light reflective layer under conditions of 50% RH and 23° C. while varying the rotational speed from 300 to 4,000 rpm. Subsequently, the product was stored for one hour at 50% RH and 23° C. to form a recordable recording layer. The thickness of the recordable recording layer was 40 nm on grooves and 15 nm on lands.

Dye described in Example 1 in Japanese Unexamined Patent Publication (KOKAI) No. 2005-228402

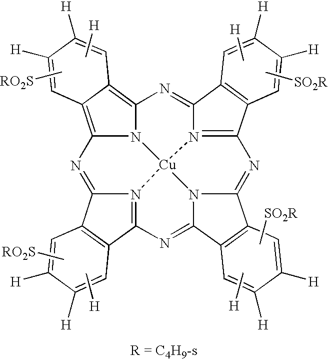

Following formation of the recordable recording layer, annealing was conducted in a clean oven. Annealing was conducted by supporting the support perpendicular to a stack pole and at some distance with a spacer for one hour at 80° C.

(Formation of Barrier Layer)

Subsequently, a barrier layer 5 nm in thickness comprised of ZnO—Ga₂O₃ (ZnO:Ga₂O₃=3:7 (weight ratio)) was formed on the recordable recording layer by RF sputtering in an argon atmosphere using a cube made by Unaxis Corp.

(Adhesion of Cover Layer)

A film (80 micrometers, Teijin Pureace) of polycarbonate having an inner diameter of 15 mm and an outer diameter of 120 mm that had been coated on one side with an acrylic adhesive (Tg: −30° C.) was employed as the cover layer. Adjustments were made so that the total thickness of the adhesive layer and the polycarbonate film was 100 micrometers. That is, the thickness of the adhesive layer was 20 micrometers.

The cover layer was positioned on the barrier layer so that the barrier layer contacted the adhesive layer, after which the cover layer was pressed down with a member, causing it to adhere.

The optical information recording medium of Example 1 was thus prepared.

### Example 2

### Preparation of Optical Information Recording Medium

With the exception that Example Compound A-16 was added to the recording layer instead of Example Compound 20, an optical information recording medium was prepared by the same method as in Example 1.

### Example 3

### Preparation of Optical Information Recording Medium

With the exception that Example Compound A-36 was added to the recording layer instead of Example Compound 20, an optical information recording medium was prepared by the same method as in Example 1.

### Example 4

### Preparation of Optical Information Recording Medium

With the exception that Dye 2 (described in Japanese Unexamined Patent Publication (KOKAI) No. 2000-52685, which is expressly incorporated herein by reference in its entirety) was added to the recording layer instead of Dye 1, an optical information recording medium was prepared by the same method as in Example 1.

Dye 2 (Dye of compound No. 7 described in Table 1 of Japanese Unexamined Patent Publication (KOKAI) No. 2000-52685)

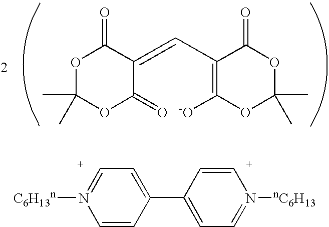

### Comparative Example 1

### Preparation of Optical Information Recording Medium

With the exception that Example Compound A-20 was not added to the recording layer, an optical information recording medium was prepared by the same method as in Example 1.

### Comparative Example 2

### Preparation of Optical Information Recording Medium

With the exception that ferrocenyl methanol was added to the recording layer instead of Example Compound A-20, an optical information recording medium was prepared by the same method as in Example 1.

### Comparative Example 3

### Preparation of Optical Information Recording Medium

With the exception that Dye 2 was added to the recording layer instead of Dye 1, an optical information recording medium was prepared by the same method as in Comparative Example 1.

<Evaluation of the Optical Information Recording Media>

### Evaluation of C/N (Carrier/Noise Ratio)

A 0.16 micrometer signal (2T) was recorded on and reproduced from the prepared optical information recording media at a clock frequency of 66 MHz and a linear speed of 4.92 m/s with an apparatus for evaluating recorded and reproduced information (DDU1000 made by Pulsetech Corp.) equipped with a 403 nm laser and an NA 0.85 pickup, and the output was measured with a spectral analyzer (FSP-3 made by Rohde-Schwarz). Peak output observed in the vicinity of 16 MHz following recording was adopted as the carrier output, and the output at the same frequency before recording was adopted as the noise output. The output following recording minus the output prior to recording was taken as the C/N value. Recording was conducted on grooves. The recording power was 4.5 mW and the reproducing power was 0.3 mW. A C/N value of equal to or greater than 35 dB was considered to be a practical level. The results are shown in Table 3.

TABLE 3

| | Dye | Additive | C/N value |
|---|---|---|---|
| Example 1 | Dye 1 | Example Compound | 45 dB |
| | | (A-20) | |
| Example 2 | Dye 1 | Example Compound | 44 dB |
| | | (A-16) | |
| Example 3 | Dye 1 | Example Compound | 42 dB |
| | | (A-36) | |
| Example 4 | Dye 2 | Example Compound | 41 dB |
| | | (A-20) | |
| Comp. Ex. 1 | Dye 1 | None | 40 dB |
| Comp. Ex. 2 | Dye 1 | Ferrocenyl methanol | 38 dB |
| Comp. Ex. 3 | Dye 2 | None | 33 dB |

Evaluation Results

The results in Table 3 reveal that the addition of Example Compound A-20, A-16, or A-36 enhanced recording characteristics.

Evaluation of Light-Toughness of Dye Solutions

To 100 mL of 2,2,3,3-tetrafluoropropanol were added and dissolved 2 g of Dye 1 and 0.2 g (10 weight percent), 0.4 g (20 weight percent), 0.6 g (30 weight percent), or 1.0 g (50 weight percent) of Example Compound A-20 to prepare dye-containing solutions. The dye-containing solutions that had been prepared were coated by spin coating under conditions of 23° C. and 50% RH while varying the rotational speed from 500 to 1,000 rpm to glass sheets 1.0 mm in thickness to form dye films. Subsequently, the glass sheets on which the dye films had been formed were stored for 24 hours at 23° C. and 50% RH and then subjected to a light resistance test with a merry-go-round type light resistance tester (made by Eagle Engineering, Inc., Cell Tester III, with WG320 filter made by Schott). The absorption spectra of the dye films immediately prior to the light resistance test and 48 hours after the light resistance test were measured with a UV-1600PC (made by Shimadzu Corp.) and the change in absorbance at the maximum absorption wavelength λ(lambda)ₘₐₓ was read. The results are given in Table 4.

TABLE 4

| | | | | | Light-toughness |
|---|---|---|---|---|---|
| Amount added of | | | Refractive index n | Absorbance k | Remaining rate |
| Example | | λₘₐₓ of dye film | at wavelength of | at wavelength of | 48 hours after |
| Compound A-20 | | (nm) | 405 nm | 405 nm | (%) |
| 0 | g | 345 | 1.81 | 0.0485 | 90.3 |
| 0.2 | g | 346 | 1.79 | 0.0481 | 94.8 |
| (10 | wt. %) | | | | |
| 0.4 | g | 346 | 1.773 | 0.0466 | 96.2 |
| (20 | wt. %) | | | | |
| 0.6 | g | 347 | 1.755 | 0.0419 | 97.2 |
| (30 | wt. %) | | | | |
| 1.0 | g | 346 | 1.732 | 0.0422 | 98.2 |
| (50 | wt. %) | | | | |

Evaluation Results

The results in Table 4 show that the addition of Example Compound A-20 enhanced light-toughness. In Table 4, the greater the quantity of Example Compound A-20 added, the smaller the amount of dye coated per unit volume, causing n and k to drop.

As indicated in Tables 3 and 4, the present invention enhanced recording characteristics and light-toughness.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. An optical information recording medium comprising a recording layer comprising a dye on a support, wherein
said recording layer comprises a compound comprising a substituent having a property of producing a gas by thermal decomposition.

2. The optical information recording medium of claim 1, wherein the compound has no absorption for a laser beam irradiated onto the optical information recording medium to record information.

3. The optical information recording medium of claim 1, wherein the dye has a property of generating heat through absorption of a laser beam irradiated onto the optical information recording medium to record information, and the compound has a property of decomposing by the heat generated by the dye.

4. The optical information recording medium of claim 2, wherein the laser beam has a wavelength ranging from 390 to 440 nm.

5. The optical information recording medium of claim 3, wherein the laser beam has a wavelength ranging from 390 to 440 nm.

6. The optical information recording medium of claim 1, wherein the substituent is a monovalent substituent denoted by general formula (I) or (VII). 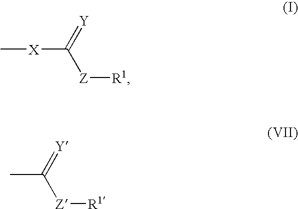
[In general formulas (I) and (VII), R¹ and R^{1′} each independently denote an alkyl group, X denotes NR², a sulfur atom, or CR³ R⁴, R², R³, and R⁴ each independently denote a hydrogen atom or a monovalent substituent, Y, Y′, Z, and Z′ each independently denote an oxygen atom or a sulfur atom.]

7. The optical information recording medium of claim 6, wherein X denotes NR².

8. The optical information recording medium of claim 1, wherein the compound is a compound denoted by general formula (V) or (VIII). 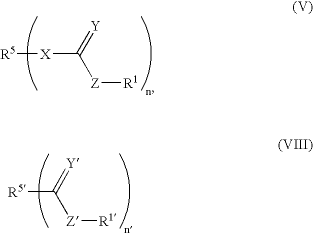
[In general formulas (V) and (VIII), R¹ and R^{1′} each independently denote an alkyl group, X denotes NR², a sulfur atom, or CR³ R⁴, R², R³, and R⁴ each independently denote a hydrogen atom or a monovalent substituent, Y, Y′, Z, and Z′ each independently denote an oxygen atom or a sulfur atom, R⁵ and R^{5′} each independently denote an alkyl group, alkenyl group, alkynyl group, aryl group, heterocyclic group, cyano group, carboxyl group, sulfamoyl group, sulfo group, alkyl or arylsulfinyl group, alkyl or arylsulfonyl group, acyl group, aryloxycarbonyl group, alkoxycarbonyl group, carbamoyl group, phosphino group, phosphinyl group, phosphinyloxy group, phosphinylamino group, or silyl group, n and n′ each independently denote an integer ranging from 1 to 6.]

9. The optical information recording medium of claim 1, wherein the compound has a thermal decomposition temperature ranging from 150 to 250° C.

10. A method of recording information on the recording layer comprised in the optical information recording medium of claim 1 by irradiation of a laser beam onto the optical information recording medium.

11. The method of recording information of claim 10, wherein
the dye comprised in the recording layer absorbs the laser beam irradiated to generate heat,
the compound comprised in the recording layer decomposes by the heat generated by the dye to produce a gas, and
the information is recorded through void generation in the recording layer by the gas produced.

12. The method of recording information of claim 10, wherein the laser beam has a wavelength ranging from 390 to 440 nm.

13. A method of using a compound comprising a substituent having a property of producing a gas by thermal decomposition as an additive in a solution comprising a dye.

14. The method of claim 13, wherein the solution is a coating liquid for forming a recording layer of an optical information recording medium.

15. The method of claim 13, wherein the substituent is denoted by general formula (I) or (VII). 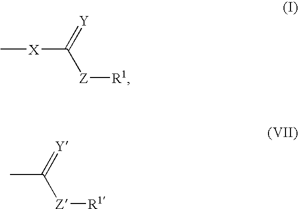
[In general formulas (I) and (VII), R¹ and R^{1′} each independently denote an alkyl group, X denotes NR², a sulfur atom, or CR³ R⁴, R², R³, and R⁴ each independently denote a hydrogen atom or a monovalent substituent, Y, Y′, Z, and Z′ each independently denote an oxygen atom or a sulfur atom.]

16. The method of claim 15, wherein X denotes NR².

17. The method of claim 13, wherein the compound is a compound denoted by general formula (V) or (VIII). 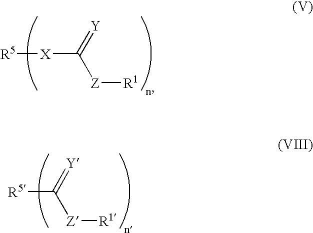
[In general formulas (V) and (VIII), R¹ and R^{1′} each independently denote an alkyl group, X denotes NR², a sulfur atom, or CR³ R⁴, R², R³, and R⁴ each independently denote a hydrogen atom or a monovalent substituent, Y, Y′, Z, and Z′ each independently denote an oxygen atom or a sulfur atom, R⁵ and R^{5′} each independently denote an alkyl group, alkenyl group, alkynyl group, aryl group, heterocyclic group, cyano group, carboxyl group, sulfamoyl group, sulfo group, alkyl or arylsulfinyl group, alkyl or arylsulfonyl group, acyl group, aryloxycarbonyl group, alkoxycarbonyl group, carbamoyl group, phosphino group, phosphinyl group, phosphinyloxy group, phosphinylamino group, or silyl group, n and n′ each independently denote an integer ranging from 1 to 6.]
